(19) United States
(12) Patent Application Publication
(10) Pub. No.: US 2026/0063931 A1
(43) Pub. Date: Mar. 5, 2026

(54) OPTICAL ELEMENT, LASER MODULE, AND NEAR-EYE WEARABLE DEVICE

(71) Applicant: TDK Corporation, Tokyo (JP)

(72) Inventors: Atsushi SHIMURA, Tokyo (JP); Yasuhiro TAKAGI, Tokyo (JP); Hiroki HARA, Tokyo (JP)

(73) Assignee: TDK Corporation, Tokyo (JP)

(21) Appl. No.: 18/797,783

(22) Filed: Aug. 8, 2024

(30) Foreign Application Priority Data
Sep. 4, 2023 (JP) 2023-143080

(51) Int. Cl. G02F 1/01; G02B 27/01

(52) U.S. Cl. CPC G02F 1/0142; G02B 27/0172; G02F 1/011; G02B 2027/0178; G02F 2203/05

(57) ABSTRACT

An optical element comprises: a substrate including a main surface; and a core layer that is provided on the main surface. The core layer includes a mode converter that converts a polarization mode of visible light. The mode converter includes: a first waveguide to which the visible light is incident in a first polarization mode that is one polarization mode of a TE mode and a TM mode; a second waveguide that emits the visible light in a second polarization mode that is the other polarization mode of the TE mode and the TM mode; and a third waveguide provided between the first waveguide and the second waveguide, the third waveguide that converts the visible light from the first polarization mode to the second polarization mode. The third waveguide has an asymmetric shape in a second direction along the main surface, the second direction intersecting the first direction.

### CROSS-REFERENCE TO RELATED APPLICATIONS

This application is based on and claims the benefit of priority from Japanese Patent Application No. 2023-143080 filed on Sep. 4, 2023, the entire contents of which are incorporated herein by reference.

### TECHNICAL FIELD

The present disclosure relates to an optical element, a laser module, and a near-eye wearable device.

### BACKGROUND

A laser module applied to a retinal projection device mounted on near-eye wearable devices such as augmented reality (AR) glasses and mixed reality (MR) glasses is known. Such a laser module includes a plurality of laser diodes and a multiplexer that multiplexes laser light emitted from respective laser diodes into laser light

A laser module as described above may include an optical modulator (for example, Japanese Unexamined Patent Publication No. 2022-36928). The optical modulator described in Japanese Unexamined Patent Publication No. 2022-36928 receives visible light emitted from a laser light source and generates a visible light signal by changing the intensity of the visible light. In the optical modulator described in Japanese Unexamined Patent Publication No. 2022-36928, an optical waveguide layer that guides the visible light is constituted by a lithium niobate film.

### SUMMARY

In a material having an electro-optical effect such as a lithium niobate film, optical characteristics such as an effective refractive index and modulation efficiency vary for each of a transverse electric (TE) mode in which a main component of an electric field is in an in-plane direction of an optical waveguide layer and a transverse magnetic (TM) mode in which the main component of the electric field is in a direction orthogonal to the in-plane direction (a main component of a magnetic field is in the in-plane direction). Therefore, in the optical modulator as described above, the modulation efficiency can vary depending on whether a polarization mode of the visible light is the TE mode or the TM mode. As described above, it may be required to set the polarization mode of the visible light to a desired polarization mode.

On the other hand, visible light emitted from the laser light source includes both TE mode visible light and TM mode visible light. Therefore, when the polarization mode of the visible light emitted from the laser light source is different from a desired polarization mode, it is necessary to convert the polarization mode of the visible light, and it is desired to improve the conversion efficiency of the polarization mode.

The present disclosure describes an optical element, a laser module, and a near-eye wearable device capable of improving conversion efficiency of a polarization mode of visible light.

An optical element according to one aspect of the present disclosure includes: a substrate including a main surface; and a core layer that is provided on the main surface and consists of a material having an electro-optical effect. The core layer includes a mode converter that extends in a first direction along the main surface and converts a polarization mode of visible light between a TM mode and a TE mode. The mode converter includes: a first waveguide to which the visible light is incident in a first polarization mode that is one polarization mode of the TE mode and the TM mode; a second waveguide that emits the visible light in a second polarization mode that is the other polarization mode of the TE mode and the TM mode; and a third waveguide that is provided between the first waveguide and the second waveguide and the third waveguide converts the visible light from the first polarization mode to the second polarization mode. The third waveguide has an asymmetric shape in a second direction along the main surface, the second direction intersecting the first direction.

In the optical element, since the core layer consists of a material having an electro-optical effect, optical characteristics such as an effective refractive index vary depending on a shape of a waveguide through which the visible light propagates. The third waveguide has an asymmetric shape in the second direction, which is a direction intersecting the first direction in which the mode converter extends, along the main surface. Since the third waveguide has such a shape, the first mixed mode and the second mixed mode in which the TE mode and the TM mode are mixed may occur in the visible light propagating through the third waveguide. Horizontal electric field component and vertical electric field component in the first mixed mode are likely to be equal. Since the second mixed mode has an orthogonal relationship with the first mixed mode, the horizontal electric field component and the vertical electric field component in the second mixed mode are likely to be equal as in the first mixed mode. Therefore, the polarization mode of the visible light propagating through the third waveguide can be converted from the first polarization mode to the second polarization mode with high conversion efficiency. As described above, according to the optical element, the conversion efficiency of the polarization mode of the visible light can be improved.

The third waveguide may include a bottom surface facing the main surface; a top surface provided on a side opposite to the bottom surface in a third direction intersecting the first direction and the second direction; and an inclined surface connecting the top surface and the bottom surface. The third waveguide may have a columnar shape in which a length in the second direction continuously increases from the top surface to the bottom surface. According to this configuration, the horizontal electric field component and the vertical electric field component in the first mixed mode are likely to be equal to each other as compared with the case where the length of the third waveguide in the second direction increases as approaching the main surface in stages. Since the second mixed mode has an orthogonal relationship with the first mixed mode, the horizontal electric field component and the vertical electric field component in the second mixed mode are likely to be equal as in the first mixed mode. Therefore, the conversion efficiency from the first polarization mode to the second polarization mode can be further improved.

An inclination angle between the inclined surface and the main surface may be from 71° to 85°. According to this configuration, the horizontal electric field component and the vertical electric field component in the first mixed mode are likely to be equal to each other as compared with the case where the inclination angle is smaller than 71° or larger than 85°. Since the second mixed mode has an orthogonal relationship with the first mixed mode, the horizontal electric field component and the vertical electric field component in the second mixed mode are likely to be equal as in the first mixed mode. Therefore, the conversion efficiency from the first polarization mode to the second polarization mode can be further improved.

The third waveguide may have a stepped shape in which a length in the second direction increases as approaching the main surface in stages. According to this configuration, the horizontal electric field component and the vertical electric field component in the first mixed mode are likely to be equal to each other. Since the second mixed mode has an orthogonal relationship with the first mixed mode, the horizontal electric field component and the vertical electric field component in the second mixed mode are likely to be equal as in the first mixed mode. Therefore, the conversion efficiency from the first polarization mode to the second polarization mode can be improved.

The third waveguide may include a bottom surface facing the main surface and a top surface provided on a side opposite to the bottom surface in a third direction intersecting the first direction and the second direction. The top surface may be provided with a groove extending in the first direction and recessed toward the bottom surface. According to this configuration, the conversion efficiency from the first polarization mode to the second polarization mode can be improved as compared with the case where the length of the third waveguide in the second direction increases as approaching the main surface in stages.

A length of a surface of the mode converter in contact with the main surface in the second direction may be from 32% to 48% of a wavelength of the visible light. According to this configuration, as compared with the case where the length in the second direction is smaller than 32% or larger than 48% of the wavelength of the visible light, the horizontal electric field component and the vertical electric field component in the first mixed mode are likely to be equal to each other. Since the second mixed mode has an orthogonal relationship with the first mixed mode, the horizontal electric field component and the vertical electric field component in the second mixed mode are likely to be equal as in the first mixed mode. Therefore, the conversion efficiency from the first polarization mode to the second polarization mode can be further improved.

A length of the mode converter in a third direction intersecting the first direction and the second direction may be smaller than a wavelength of the visible light. According to this configuration, since the length in the third direction is smaller than the wavelength of the visible light, the horizontal electric field component and the vertical electric field component in the first mixed mode are likely to be equal to each other. Since the second mixed mode has an orthogonal relationship with the first mixed mode, the horizontal electric field component and the vertical electric field component in the second mixed mode are likely to be equal as in the first mixed mode. Therefore, the conversion efficiency from the first polarization mode to the second polarization mode can be further improved.

The core layer may include: a first mode converter that is the mode converter which converts a polarization mode of red light from the first polarization mode to the second polarization mode; a second mode converter that is the mode converter which converts a polarization mode of green light from the first polarization mode to the second polarization mode; a third mode converter that is the mode converter which converts a polarization mode of blue light from the first polarization mode to the second polarization mode; and a multiplexer that multiplexes the red light, the green light, and the blue light to emit multiplexed laser light. According to this configuration, the polarization modes of the red light, the green light, and the blue light are converted from the first polarization mode to the second polarization mode. The polarization mode having the higher multiplexing efficiency in the multiplexer of the TM mode and the TE mode is used as the second polarization mode, so that the multiplexing efficiency can be improved.

Lengths of the first mode converter, the second mode converter, and the third mode converter in a third direction intersecting the first direction and the second direction may be the same as each other. According to this configuration, the first mode converter, the second mode converter, and the third mode converter can be formed on the same substrate, and the lengths of the respective mode converters in the third direction can be made the same as each other, so that the optical device can be easily manufactured.

The core layer may further include: a first modulator that modulates an optical intensity of the red light; a second modulator that modulates an optical intensity of the green light; and a third modulator that modulates an optical intensity of the blue light. In order to output full-color laser light by multiplexing the red light, the green light, and the blue light, it is necessary to adjust the optical intensity of light of each color in correspondence with the color to be output. According to the above configuration, since the optical intensity of the red light, the optical intensity of the green light, and the optical intensity of the blue light are modulated, it is possible to output full-color laser light.

A laser module according to another aspect of the present disclosure includes: the optical element described above; a first laser light source that emits the red light in the first polarization mode; a second laser light source that emits the green light in the first polarization mode; and a third laser light source that emits the blue light in the first polarization mode. Since this laser module includes the above-described optical element, conversion efficiency of a polarization mode of the visible light can be improved.

A near-eye wearable device according to still another aspect of the present disclosure includes: the laser module described above; a movable mirror that performs scanning by using the laser light emitted from the laser module; and a reflector that reflects the laser light that has passed through the movable mirror and guides the laser light to a retina of a user wearing the near-eye wearable device to project an image onto the retina. Since the near-eye wearable device includes the optical element described above, it is possible to project an image onto the retina while improving conversion efficiency of a polarization mode of the visible light.

According to each aspect and each embodiment of the present disclosure, conversion efficiency of a polarization mode of visible light can be improved.

### BRIEF DESCRIPTION OF THE DRAWINGS

FIG. 1 is a perspective view illustrating an appearance of a near-eye wearable device to which a laser module according to an embodiment is applied;

FIG. 2 is a configuration diagram schematically illustrating a retinal projection device illustrated in FIG. 1;

FIG. 3 is a block diagram of a laser module illustrated in FIG. 2;

FIG. 4 is a perspective view illustrating a configuration of a mode converter illustrated in FIG. 3;

FIG. 5 is a cross-sectional view taken along line V-V of FIG. 4;

FIG. 6 is a cross-sectional view taken along line VI-VI of FIG. 4;

FIG. 7 is a cross-sectional view taken along line VII-VII of FIG. 4;

FIG. 8 is a diagram for explaining a mode conversion operation of the mode converter illustrated in FIG. 4;

FIG. 9 is a graph illustrating an example of conversion efficiency in the mode converter illustrated in FIG. 4;

FIG. 10A is a block diagram of a laser module according to another embodiment;

FIG. 10B is a block diagram of a laser module according to still another embodiment;

FIG. 11 is a block diagram of a laser module according to still another embodiment;

FIG. 12A is a cross-sectional view of a waveguide according to a first modification example;

FIG. 12B is a graph illustrating an example of conversion efficiency in the mode converter including the waveguide according to the first modification example;

FIG. 13A is a cross-sectional view of a waveguide according to a second modification example;

FIG. 13B is a graph illustrating an example of conversion efficiency in the mode converter including the waveguide according to the second modification example;

FIG. 14A is a cross-sectional view of a waveguide according to a third modification example;

FIG. 14B is a graph illustrating an example of conversion efficiency in the mode converter including the waveguide according to the third modification example;

FIG. 15A is a diagram illustrating evaluation results of Example 1;

FIG. 15B is a diagram illustrating evaluation results of Example 2;

FIG. 15C is a diagram illustrating evaluation results of Example

3;

FIG. 16 is a diagram illustrating evaluation results of Example 4;

FIG. 17A is a diagram illustrating evaluation results of Example 5;

FIG. 17B is a diagram illustrating evaluation results of Example 6; and

FIG. 17C is a diagram illustrating evaluation results of Example 7.

### DETAILED DESCRIPTION

Hereinafter, embodiments of the present disclosure will be described in detail with reference to the drawings. In the description of the drawings, the same elements are denoted by the same reference numerals, and redundant description will be omitted. In each figure, an XYZ coordinate system may be shown. The Y-axis direction (second direction) is a direction intersecting (for example, orthogonal to) the X-axis direction (first direction) and the Z-axis direction (third direction). The Z-axis direction is a direction intersecting (for example, orthogonal to) the X-axis direction and the Y-axis direction. In the present specification, the numerical ranges indicated by “to” represent ranges that include the values described before and after “to” as the minimum and maximum values, respectively. The individually described upper and lower limits can be combined arbitrarily.

### EMBODIMENT

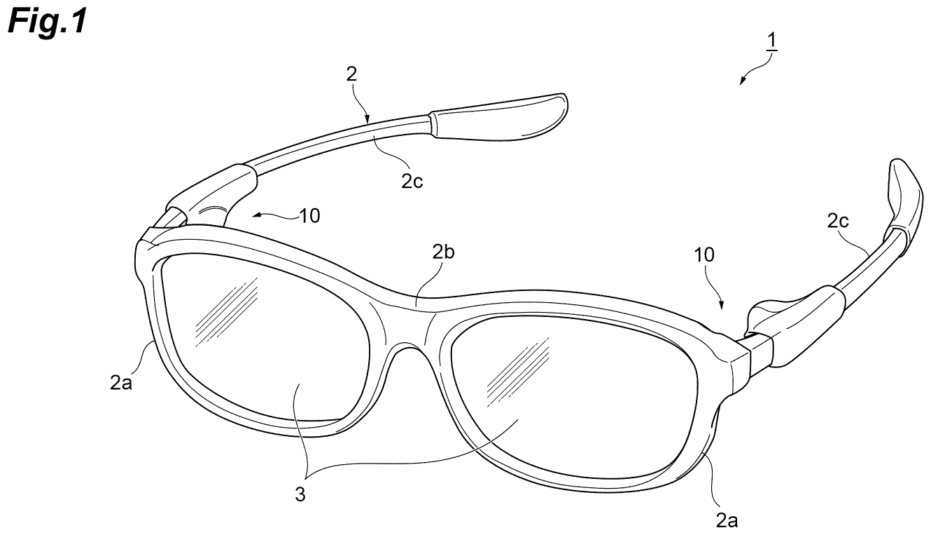

A laser module according to an embodiment will be described with reference to FIG. 1. FIG. 1 is a perspective view illustrating an appearance of a near-eye wearable device to which a laser module according to an embodiment is applied. The near-eye wearable device 1 illustrated in FIG. 1 is a device that projects images onto the retina of a user wearing the near-eye wearable device 1. The near-eye wearable device 1 is, for example, a head-mounted device, and may take the form of an eyeglass type, a goggle type, a hat type, a helmet type, or the like. Examples of the near-eye wearable device 1 include smart glasses such as augmented reality (AR) glasses, virtual reality (VR) glasses, and mixed reality (MR) glasses. The near-eye wearable device 1 includes a frame 2, a lens 3, and a retinal projection device 10.

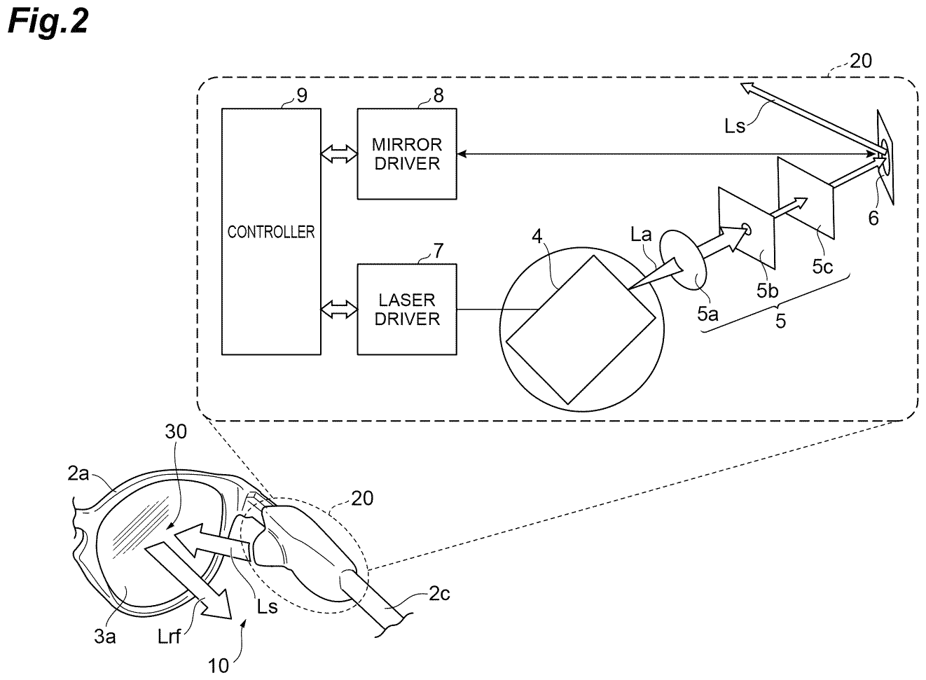

The frame 2 includes a pair of rims 2a, a bridge 2b, and a pair of temples 2c. The rim 2a is a portion for holding the lens 3. The bridge 2b is a portion connecting the pair of rims 2a. The temple 2c extends from the rim 2a and is a portion to be put on an ear of a user. The frame 2 may be a rimless frame. The lens 3 includes an inner surface 3a (refer to FIG. 2) facing an eyeball of a user wearing the near-eye wearable device 1.

The retinal projection device 10 is a device for directly projecting (drawing) an image onto a retina of a user wearing the near-eye wearable device 1. The retinal projection device 10 is mounted on the near-eye wearable device 1. In the present embodiment, the near-eye wearable device 1 includes two retinal projection devices 10 in order to project an image onto both the right and left retinas, but may include only one of the retinal projection devices 10.

Next, the retinal projection device 10 will be described in detail with reference to FIG. 2. FIG. 2 is a configuration diagram schematically illustrating the retinal projection device shown in FIG. 1. As shown in FIG. 2, the retinal projection device 10 includes an optical engine 20 and a reflector 30.

The optical engine 20 is a device which generates a laser light Ls having a color and light intensity corresponding to a pixel of an image to be projected onto the retina and emits the laser light Ls to the reflector 30. The optical engine 20 is mounted on each temple 2c. The optical engine 20 includes a laser module 4, optical components 5, a movable mirror 6, a laser driver 7, a mirror driver 8, and a controller 9.

The laser module 4 emits a laser light La, which is visible light. As the laser module 4, for example, a full-color laser module is used. The laser module 4 emits a laser light La having a color and light intensity corresponding to a pixel of an image to be projected onto the retina. Details of the laser module 4 will be described later.

The optical components 5 are components that optically process the laser light La emitted from the laser module 4. In the present embodiment, the optical components 5 include a collimator lens 5a, a slit 5b, and a neutral density filter 5c. The collimator lens 5a, the slit 5b, and the neutral density filter 5c are arranged in this order along the optical path of the laser light La. The optical components 5 may have other configurations.

The movable mirror 6 is a member for performing scanning with the laser light Ls. The movable mirror 6 is provided in a direction in which the laser light La processed by the optical components 5 is emitted. The movable mirror 6 is swingable about an axis extending in the horizontal direction of the lens 3 and about an axis extending in the vertical direction of the lens 3, for example, and reflects the laser light La to emit the reflected light Ls while changing the angle in the horizontal direction and the vertical direction. As the movable mirror 6, for example, a micro electro mechanical systems (MEMS) mirror is used.

The laser driver 7 is a driving circuit for driving the laser module 4. The laser driver 7 drives the laser module 4 based on, for example, the optical power of the laser light La and the temperatures of the laser light sources 411, 412, and 413 included in the laser module 4. The mirror driver 8 is a driving circuit for driving the movable mirror 6. The mirror driver 8 swings the movable mirror 6 within a predetermined angle range and at a predetermined timing. The controller 9 is a device for controlling the laser driver 7 and the mirror driver 8.

In the optical engine 20, a laser light La having a color and light intensity corresponding to a pixel of an image to be projected onto the retina is emitted from the laser module 4, passes through the optical components 5, and is reflected by the movable mirror 6. The laser light La reflected by the movable mirror 6 is emitted to the reflector 30 as the laser light Ls.

The reflector 30 is a member that projects an image onto the retina of the user wearing the near-eye wearable device 1 by reflecting the laser light Ls having passed through the movable mirror 6 and irradiating the retina with reflected light Lrf.

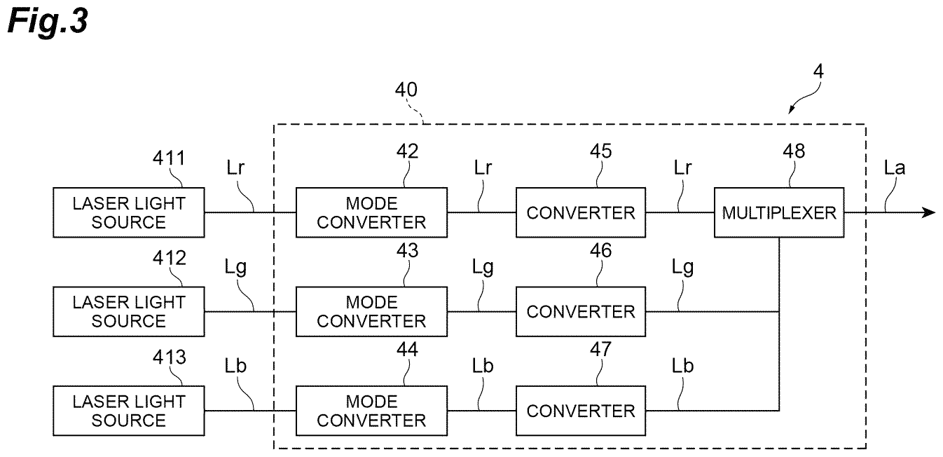

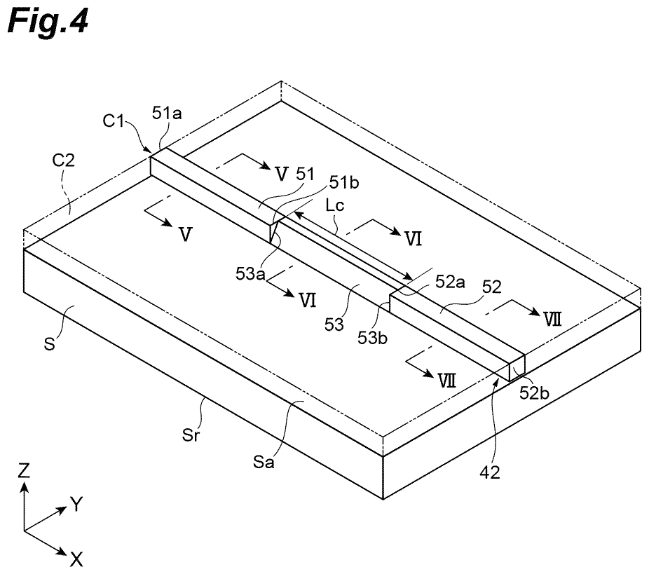

Next, a configuration of the laser module 4 will be described with reference to FIGS. 3 and 4. FIG. 3 is a block diagram of a laser module illustrated in FIG. 2. FIG. 4 is a perspective view illustrating a configuration of a mode converter illustrated in FIG. 3. FIG. 4 illustrates only a peripheral portion of a mode converter 42 in an optical element 40.

As illustrated in FIG. 3, the laser module 4 includes the optical element 40, a laser light source 411 that emits red light Lr, a laser light source 412 that emits green light Lg, and a laser light source 413 that emits blue light Lb. The laser light source 411 is, for example, a red laser diode. The laser light source 412 is, for example, a green laser diode. The laser light source 413 is, for example, a blue laser diode. A peak wavelength of the red light Lr is, for example, in a range of 600 nm to 830 nm. A peak wavelength of the green light Lg is, for example, in a range of 500 nm to 570 nm. A peak wavelength of the blue light Lb is, for example, in a range of 380 nm to 490 nm.

In the present embodiment, the laser light source 411 emits the red light Lr in a TE mode. The laser light source 412 emits the green light Lg in the TE mode. The laser light source 413 emits the blue light Lb in the TE mode. Since the red light Lr, the green light Lg, and the blue light Lb are all visible light, in the following description, the red light Lr, the green light Lg, and the blue light Lb may be referred to as each visible light, and the red light Lr, the green light Lg, and the blue light Lb may be collectively referred to as visible light.

The optical element 40 multiplexes the visible light emitted from each laser light source into one laser light La. The optical element 40 is, for example, a planar lightwave circuit (PLC). As illustrated in FIG. 4, the optical element 40 includes a substrate S, a core layer C1, and a cladding layer C2.

The substrate S functions as a lower cladding layer. The substrate S essentially consists of a material having a refractive index lower than that of a constituent material of the core layer C1. Examples of the constituent material of the substrate S include sapphire, silicon, and aluminum oxide (Al₂O₃). The substrate S includes a main surface Sa and a rear surface Sr opposite to the main surface Sa. The main surface Sa and the rear surface Sr are surfaces defined by the X-axis direction and the Y-axis direction, and intersect (in the present embodiment, orthogonal to) the Z-axis direction. In other words, the X-axis direction and the Y-axis direction are directions along the main surface Sa.

The cladding layer C2 functions as an upper cladding layer. The cladding layer C2 covers the core layer C1 on the main surface Sa. The cladding layer C2 essentially consists of a material having a refractive index lower than that of a constituent material of the core layer C1. Examples of the constituent material of the cladding layer C2 include silicon oxide (for example, SiO₂).

The core layer C1 is provided on the main surface Sa. The core layer C1 essentially consists of a material having an electro-optical effect. The electro-optical effect is a phenomenon in which a refractive index of a material varies when applying an electric field to the material. An example of the constituent material of the core layer C1 is lithium niobate (LiNbO₃). In a material having an electro-optical effect, optical characteristics such as an effective refractive index and modulation efficiency vary for each of a transverse electric (TE) mode in which a main component of an electric field is in an in-plane direction of an optical waveguide layer and a transverse magnetic (TM) mode in which the main component of the electric field is in a direction orthogonal to the in-plane direction (a main component of a magnetic field is in the in-plane direction).

In the present embodiment, the core layer C1 is a lithium niobate thin film formed on the main surface Sa of the substrate S by sputtering, and an optical axis (C-axis) of lithium niobate extends in the Z-axis direction. In this case, the modulation efficiency of each modulator is improved in the TM mode. Therefore, in the present embodiment, the visible light in the TE mode is emitted from each laser light source, and each visible light is converted into the TM mode in each mode converter to be incident to each modulator. The core layer C1 may essentially consist of Z-cut lithium niobate.

The core layer C1 includes the mode converter 42, a mode converter 43, a mode converter 44, a modulator 45, a modulator 46, a modulator 47, and a multiplexer 48.

The mode converter 42 is a mode converter that converts the polarization mode of the red light Lr between the TM mode and the TE mode. In the present embodiment, the mode converter 42 converts the polarization mode of the red light Lr from the TE mode (first polarization mode) to the TM mode (second polarization mode). The red light Lr is incident from the laser light source 411 to an incident end of the mode converter 42. The mode converter 43 is a mode converter that converts the polarization mode of the green light Lg between the TM mode and the TE mode. In the present embodiment, the mode converter 43 converts the polarization mode of the green light Lg from the TE mode to the TM mode. The green light Lg is incident from the laser light source 412 to an incident end of the mode converter 43. The mode converter 44 is a mode converter that converts the polarization mode of the blue light Lb between the TM mode and the TE mode. In the present embodiment, the mode converter 44 converts the polarization mode of the blue light Lb from the TE mode to the TM mode. The blue light Lb is incident from the laser light source 413 to an incident end of the mode converter 44.

Each of the mode converter 42, the mode converter 43, and the mode converter 44 extends in the X-axis direction. The mode converter 42, the mode converter 43, and the mode converter 44 are arranged in this order in the Y-axis direction. The lengths of the mode converter 42, the mode converter 43, and the mode converter 44 in the Z-axis direction are substantially equal to each other. Hereinafter, the length in the Z-axis direction may be referred to as “height”. The height of the mode converter 42, the height of the mode converter 43, and the height of the mode converter 44 may be different from each other. A detailed configuration of each mode converter will be described later.

The modulator 45 is a modulator that modulates the optical intensity of the red light Lr. An incident end of the modulator 45 is optically connected to an emission end of the mode converter 42. The modulator 45 modulates the optical intensity of the TM mode red light Lr emitted from the mode converter 42. The modulator 46 is a modulator that modulates the optical intensity of the green light Lg. An incident end of the modulator 46 is optically connected to an emission end of the mode converter 43. The modulator 46 modulates the optical intensity of the TM mode green light Lg emitted from the mode converter 43. The modulator 47 is a modulator that modulates the optical intensity of the blue light Lb. An incident end of the modulator 47 is optically connected to an emission end of the mode converter 44. The modulator 47 modulates the optical intensity of the TM mode blue light Lb emitted from the mode converter 44. Each modulator is, for example, a Mach-Zehnder modulator.

The multiplexer 48 multiplexes the red light Lr, the green light Lg, and the blue light Lb modulated in each modulator into one visible light. The three incident ends of the multiplexer 48 are optically connected to the emission ends of the modulator 45, the modulator 46, and the modulator 47, respectively. The multiplexer 48 emits the multiplexed visible light as the laser light La from the emission end of the multiplexer 48.

In the laser module 4, the visible light is emitted from each laser light source in the TE mode, and after the polarization mode of the visible light is converted from the TE mode to the TM mode in each mode converter, the optical intensity of each visible light is modulated in each modulator. Then, each modulated visible light is multiplexed in the multiplexer 48 to be emitted from the multiplexer 48 to the optical components 5 (refer to FIG. 2) as the TM mode laser light La.

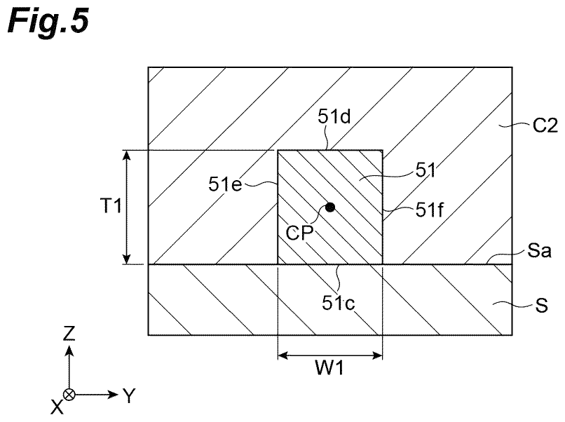

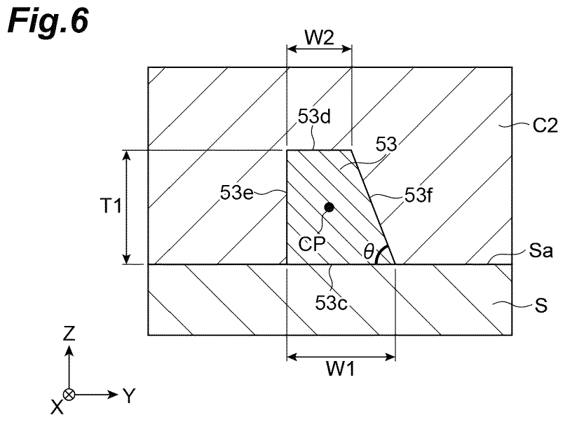

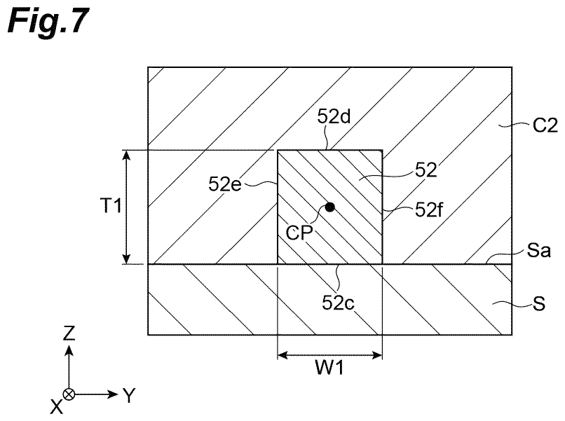

Next, specific configurations of the mode converter 42, the mode converter 43, and the mode converter 44 will be described with reference to FIGS. 4 to 7. FIG. 5 is a cross-sectional view taken along line V-V of FIG. 4. FIG. 6 is a cross-sectional view taken along line VI-VI of FIG. 4. FIG. 7 is a cross-sectional view taken along line VII-VII of FIG. 4. As illustrated in FIG. 4, each of the mode converter 42, the mode converter 43, and the mode converter 44 includes a waveguide 51, a waveguide 52, and a waveguide 53. Since the configurations of the mode converter 42, the mode converter 43, and the mode converter 44 are the same as each other, the mode converter 42 will be described here as an example.

The waveguide 53 is provided between the waveguide 51 and the waveguide 52. Specifically, the waveguide 51, the waveguide 52, and the waveguide 53 are linearly arranged in the order of the waveguide 51, the waveguide 53, and the waveguide 52 in a traveling direction (X-axis direction) of the red light Lr.

The waveguide 51 is an optical waveguide located at one end (incident end) in the X-axis direction of the mode converter 42. The waveguide 51 has a columnar shape extending linearly in the X-axis direction. Specifically, the waveguide 51 has a rectangular parallelepiped shape whose longitudinal direction is the X-axis direction. The waveguide 51 includes an incident end 51a that is one end in the X-axis direction and an emission end 51b that is the other end in the X-axis direction. The red light Lr is incident to the incident end 51a from the laser light source 411 in the TE mode. The waveguide 51 transmits the red light Lr while maintaining the polarization mode of the red light Lr, and emits the red light Lr from the emission end 51b of the waveguide 51 to the waveguide 53 in the TE mode.

The waveguide 51 is symmetric in the Z-axis direction and is symmetric in the Y-axis direction. Being symmetric in the Z-axis direction represents that two portions separated by a symmetry plane are plane-symmetric with respect to the symmetry plane that passes through a center point (in a case of the waveguide 51, a center point CP in a cross-section of the waveguide 51 illustrated in FIG. 5) in the Z-axis direction and is orthogonal to the Z-axis direction. Being symmetric in the Y-axis direction represents that two portions separated by a symmetry plane are plane-symmetric with respect to the symmetry plane that passes through a center point (in the case of the waveguide 51, the center point CP) in the Y-axis direction and is orthogonal to the Y-axis direction.

As illustrated in FIG. 5, the waveguide 51 includes a bottom surface 51c facing the main surface Sa, a top surface 51d provided on a side opposite to the bottom surface 51c in the Z-axis direction, and side surfaces 51e and 51f which are a pair of side surfaces connecting the bottom surface 51c and the top surface 51d. The entire bottom surface 51c is in contact with the main surface Sa. The bottom surface 51c and the top surface 51d are substantially parallel to each other, and the side surface 51e and the side surface 51f are substantially parallel to each other. The height and the length in the Y-axis direction of the waveguide 51 are constant from the incident end 51a to the emission end 51b. Hereinafter, the length in the Y-axis direction may be referred to as a “width”. The height of the waveguide 51 is a height T1, and the width of the waveguide 51 is a width W1. The height T1 is smaller than the wavelength of the red light Lr. The width W1 may be 20% to 60% or 32% to 48% of the wavelength of the red light Lr.

The waveguide 53 is an optical waveguide that converts the polarization mode of the red light Lr between the TM mode and the TE mode. In the present embodiment, the waveguide 53 converts the polarization mode of the red light Lr from the TE mode to the TM mode. The waveguide 53 has a columnar shape extending linearly in the X-axis direction. Specifically, the waveguide 53 has a shape in which a corner portion formed by the top surface 51d and the side surface 51f of the waveguide 51 is missing. The waveguide 53 includes an incident end 53a that is one end in the X-axis direction and an emission end 53b that is the other end in the X-axis direction.

The incident end 53a is connected to the emission end 51b. The emission end 53b is connected to the waveguide 52. The red light Lr is incident to the incident end 53a from the waveguide 51 in the TE mode. The waveguide 53 converts the polarization mode of the red light Lr from the TE mode to the TM mode, and emits the red light Lr from the emission end 53b to the waveguide 52 in the TM mode. The length between the incident end 53a and the emission end 53b is defined as a conversion length Lc. Although details will be described later, the conversion length Lc is a parameter that contributes to conversion efficiency in conversion of the polarization mode of the red light Lr from the TE mode to the TM mode.

The waveguide 53 is asymmetric in the Z-axis direction and is asymmetric in the Y-axis direction. Being asymmetric in the Z-axis direction represents that two portions separated by a symmetry plane are not plane-symmetric with respect to the symmetry plane that passes through a center point (in a case of the waveguide 53, a center point CP in a cross-section of the waveguide 53 illustrated in FIG. 6) in the Z-axis direction and is orthogonal to the Z-axis direction. Similarly, being asymmetric in the Y-axis direction represents that two portions separated by a symmetry plane are not plane-symmetric with respect to the symmetry plane that passes through a center point (in the case of the waveguide 53, the center point CP) in the Y-axis direction and is orthogonal to the Y-axis direction.

As illustrated in FIG. 6, the waveguide 53 includes a bottom surface 53c facing the main surface Sa, a top surface 53d provided on a side opposite to the bottom surface 53c in the Z-axis direction, a side surface 53e connecting the bottom surface 53c and the top surface 53d, and an inclined surface 53f connecting the bottom surface 53c and the top surface 53d. The entire bottom surface 53c is in contact with the main surface Sa. The bottom surface 53c and the top surface 53d are substantially parallel to each other.

An angle between the side surface 53e and the bottom surface 53c (main surface Sa) is a right angle. The inclined surface 53f is inclined so as to be away from the side surface 53e as approaching the main surface Sa. An inclination angle θ between the inclined surface 53f and the bottom surface 53c (main surface Sa) is smaller than 90°. The inclination angle θ may be in a range of 71° to 83°, or may be in a range of 73° to 81°. That is, a cross-sectional shape of the waveguide 53 orthogonal to the X-axis direction is a right-angled trapezoid. A height, a width at the bottom surface 53c, and a width at the top surface 53d of the waveguide 53 are constant from the incident end 53a to the emission end 53b. The height of the waveguide 53 is the same as the height of the waveguide 51 and is a height T1. The width of the waveguide 53 at the bottom surface 53c is the same as the width of the waveguide 51, and is a width W1. The width of the waveguide 53 at the top surface 53d is shorter than the width of the waveguide 53 at the bottom surface 53c and is a width W2.

The waveguide 52 is an optical waveguide located at the other end (emission end) in the X-axis direction of the mode converter 42. The waveguide 52 has a columnar shape extending linearly in the X-axis direction. Specifically, the waveguide 52 has a rectangular parallelepiped shape whose longitudinal direction is the X-axis direction, and a cross-sectional shape of the waveguide 52 orthogonal to the X-axis direction is the same as a cross-sectional shape of the waveguide 51 orthogonal to the X-axis direction. The waveguide 52 includes an incident end 52a that is one end in the X-axis direction and an emission end 52b that is the other end in the X-axis direction. The incident end 52a is connected to the emission end 53b. The emission end 52b is connected to the incident end of the modulator 45. The red light Lr is incident to the incident end 52a from the waveguide 53 in the TM mode. The waveguide 52 transmits the red light Lr while maintaining the polarization mode of the red light Lr, and emits the red light Lr from the emission end 52b to the modulator 45 in the TM mode.

The waveguide 52 is symmetric in the Z-axis direction and is symmetric in the Y-axis direction. As illustrated in FIG. 7, the waveguide 52 includes a bottom surface 52c facing the main surface Sa, a top surface 52d provided on a side opposite to the bottom surface 52c in the Z-axis direction, and side surfaces 52e and 52f which are a pair of side surfaces connecting the bottom surface 52c and the top surface 52d. The entire bottom surface 52c is in contact with the main surface Sa. The bottom surface 52c and the top surface 52d are substantially parallel to each other, and the side surface 52e and the side surface 52f are substantially parallel to each other. A height and a width of the waveguide 52 are constant from the incident end 52a to the emission end 52b. The height of the waveguide 52 is the same as the height of the waveguide 51, and is the height T1. The width of the waveguide 52 is the same as the width of the waveguide 51, and is the width W1.

The bottom surface 51c, the bottom surface 53c, and the bottom surface 52c are connected in this order and are located on the same plane. The side surface 51e, the side surface 53e, and the side surface 52e are connected in this order and are located on the same plane. The top surface 51d, the top surface 53d, and the top surface 52d are connected in this order and are located on the same plane.

Although the above-described configuration is the same in the mode converter 43 and the mode converter 44, optimum dimensions may be different in each of the mode converter 42, the mode converter 43, and the mode converter 44. The optimum dimensions noted herein is optimum dimensions for maximizing the conversion efficiency of each visible light polarization mode. The inclination angle θ in the mode converter 42 may be in a range of 71° to 83° or in a range of 73° to 81°. The inclination angle θ in the mode converter 43 may be in a range of 74° to 85° or in a range of 77° to 83°. The inclination angle θ in the mode converter 44 may be in a range of 74° to 85° or in a range of 77° to 83°. Therefore, the maximum range of the inclination angle θ in the mode converter 42, the mode converter 43, and the mode converter 44 is 71° to 85°.

The width (width W1) of the surface (bottom surface 51c, 52c, or 53c) in contact with the main surface Sa of each mode converter may be 20% to 60% or 32% to 48% of the wavelength of the visible light propagating through each mode converter. The height T1 is smaller than the wavelength of the visible light propagating through each mode converter. Specifically, the height T1 may be 1 μm or less, or 0.6 μm or less.

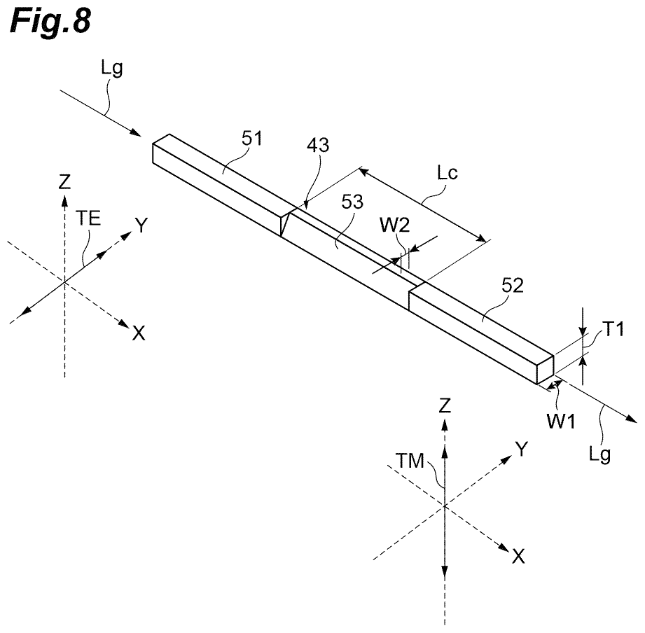

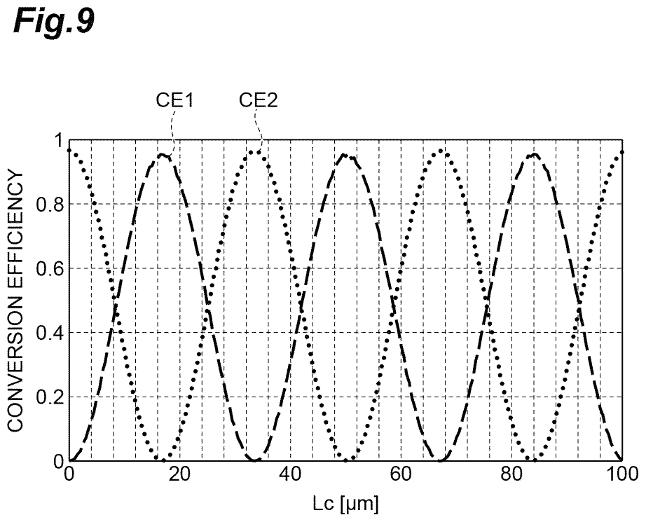

Next, operations of the mode converter 42, the mode converter 43, and the mode converter 44 will be described with reference to FIGS. 8 and 9. FIG. 8 is a diagram for explaining a mode conversion operation of the mode converter illustrated in FIG. 4. FIG. 9 is a graph illustrating an example of conversion efficiency in the mode converter illustrated in FIG. 4. In the graph in FIG. 9, the horizontal axis represents the conversion length Lc [μm], and the vertical axis represents the conversion efficiency. Since operations of the mode converter 42, the mode converter 43, and the mode converter 44 are the same as each other, the mode converter 43 will be exemplified here.

As illustrated in FIG. 8, in the mode converter 43, the green light Lg is incident in the TE mode in the waveguide 51, the polarization mode of the green light Lg is converted from the TE mode to the TM mode in the waveguide 53, and the green light Lg in the TM mode is emitted from the waveguide 52. In this example, the wavelength of the green light Lg is 520 nm, the width W1 is set to 0.20 μm, the width W2 is set to 0.15 μm, and the height T1 is set to 0.30 μm.

As illustrated in FIG. 8, in the waveguide 51, since the polarization mode of the green light Lg is the TE mode, a vector of an electric field component is parallel to the Y-axis direction. When the green light Lg is incident to the waveguide 53, since the waveguide 53 is asymmetric in the Y-axis direction and asymmetric in the Z-axis direction, two mixed modes (first mixed mode and second mixed mode) in which the TE mode and the TM mode are mixed are excited as the polarization mode of the green light Lg. At this time, horizontal electric field component in the first mixed mode and the horizontal electric field component in the second mixed mode vary depending on a shape and a size of the waveguide 53.

In the present embodiment, the horizontal electric field component and vertical electric field component in the first mixed mode are likely to be equal. Since the second mixed mode has an orthogonal relationship with the first mixed mode, the horizontal electric field component and the vertical electric field component in the second mixed mode are likely to be equal as in the first mixed mode. For example, in the first mixed mode, the horizontal electric field component is 50% of the entire field of the first mixed mode. Similarly, in the second mixed mode, the horizontal electric field component is 50% of the entire field of the second mixed mode. In this case, the electric field vector in the first mixed mode rotates by 45° from the Y-axis direction. The electric field vector in the second mixed mode rotates by 45° from the Z-axis direction. The electric field vector in the first mixed mode is orthogonal to the electric field vector in the second mixed mode.

In the waveguide 53, since there is a difference between a propagation constant B1 of the first mixed mode and a propagation constant B2 of the second mixed mode, a phase difference occurs between a phase of the first mixed mode and a phase of the second mixed mode depending on the length of the green light Lg propagating through the waveguide 53. When the phase difference is π×(2n+1) (n is an integer of 0 or more), the first mixed mode and the second mixed mode are coupled to one mode when the green light Lg propagates from the emission end 53b of the waveguide 53 to the waveguide 52, and the polarization mode of the green light Lg is rotated by 90° from the TE mode to be converted into the TM mode.

Conversion efficiency (CE) in the mode converter is expressed by Equation (1) by using the rotation angle φ, the conversion length Lc, and the length L_{π}. Note that a unit of CE in Equation (1) is %. A tangent of the rotation angle φ is expressed by Equation (2) by using a permittivity distribution ε(y, z), an electric field component Ey(y, z) in the mixed mode in the horizontal direction, and an electric field component Ez(y, z) in the mixed mode in the vertical direction.

$$\begin{matrix}[ Equation 1 ] & \\ CE = {sin}^{2} ( 2 φ ) {sin}^{2} ( \frac{π {L}_{c}}{2 {L}_{π}} ) \times 100 & ( 1 )\end{matrix}$$

$$\begin{matrix}[ Equation 2 ] & \\ tan ( φ ) = \frac{\int {\int }_{Ω} ε ( y , z ) \cdot {E}_{y}^{2} ( y , z ) dy dz}{\int {\int }_{Ω} ε ( y , z ) \cdot {E}_{z}^{2} ( y , z ) dy dz} & ( 2 )\end{matrix}$$

Here, the rotation angle φ is a rotation angle between an optical axis in the mixed mode and a plane parallel to the main surface Sa of the substrate S. The length L_{π} is a length at which the phase difference between the first mixed mode and the second mixed mode becomes π. A derivation equation of the conversion length Lc will be described later. From Equation (1), conversion efficiency close to 100% can be obtained when the rotation angle φ is 45°. From the Equation (2), when the horizontal electric field component Ey(y, z) and the vertical electric field component Ez(y, z) in the first mixed mode and the second mixed mode are equal to each other, the rotation angle φ becomes 45°. From the above, when the horizontal electric field component Ey(y, z) and the vertical electric field component Ez(y, z) in the first mixed mode and the second mixed mode are equal to each other, a conversion efficiency close to 100% can be obtained.

As illustrated in FIG. 9, conversion efficiency CE1 indicates conversion efficiency when the polarization mode of the green light Lg incident as the TE mode is converted into the TM mode. Conversion efficiency CE2 indicates conversion efficiency when the polarization mode of the green light Lg incident as the TE mode is emitted as the TE mode. The conversion efficiency CE1 and the conversion efficiency CE2 periodically vibrate as the conversion length Lc increases, and a maximum value of the conversion efficiency CE1 and a maximum value of the conversion efficiency CE2 alternately appear for every half cycle. Both the maximum values exceed 0.95, and it will be understood that high conversion efficiency can be realized. In the present embodiment, since the waveguide 53 converts the green light Lg in the TE mode into the green light Lg in the TM mode, the conversion length Lc is set to a length at which the conversion efficiency CE1 takes a maximum value. The conversion length Lc is calculated by Equation (3).

$$\begin{matrix}[ Equation 3 ] & \\ Lc = \frac{π}{{β}_{1} - {β}_{2}} = \frac{π}{( {n}_{eff 1} - {n}_{eff 2} ) \times {k}_{0}} & ( 3 )\end{matrix}$$

n_{eff1} represents an effective refractive index of the first mixed mode, n_{eff2} represents an effective refractive index of the second mixed mode, and k₀ represents a vacuum wave number. In this example, the conversion length Lc is calculated to be 17.44 μm by Equation (3). As illustrated in FIG. 9, when the conversion length Lc is 17.44 μm, the conversion efficiency at the time of conversion from the TE mode to the TM mode is 0.97.

In the laser module 4 and the optical element 40 described above, since the core layer C1 essentially consists of a material having an electro-optical effect, optical characteristics such as an effective refractive index vary depending on the shape of the waveguide through which the visible light propagates. The waveguide 53 of each mode converter has an asymmetric shape in the Y-axis direction. Since the waveguide 53 has such a shape, the first mixed mode and the second mixed mode in which the TE mode and the TM mode are mixed may occur in the visible light propagating through the waveguide 53. The horizontal electric field component and the vertical electric field component in the first mixed mode are likely to be equal. Since the second mixed mode has an orthogonal relationship with the first mixed mode, the horizontal electric field component and the vertical electric field component in the second mixed mode are likely to be equal as in the first mixed mode. Therefore, the polarization mode of the visible light propagating through the waveguide 53 can be converted from the TE mode to the TM mode with high conversion efficiency. As described above, according to the optical element 40, the conversion efficiency of the polarization mode of the visible light can be improved.

The waveguide 53 has a columnar shape whose length in the Y-axis direction is continuously increased from the top surface 53d to the bottom surface 53c. According to this configuration, as compared with a case where the length of the waveguide 53 in the Y-axis direction increases as approaching the main surface Sa in stages (a waveguide 54 and a waveguide 54A to be described later), the horizontal electric field component and the vertical electric field component in the first mixed mode are likely to be equal to each other. Since the second mixed mode has an orthogonal relationship with the first mixed mode, the horizontal electric field component and the vertical electric field component in the second mixed mode are likely to be equal as in the first mixed mode. Therefore, the conversion efficiency from the TE mode to the TM mode can be further improved.

In addition, since the waveguide 53 includes the inclined surface 53f, it is possible to make the waveguide 53 asymmetric in the Y-axis direction while minimizing a decrease in a cross-sectional area of the waveguide 53. Therefore, the cross-sectional area of the waveguide 53 is suppressed from becoming extremely small with respect to cross-sectional areas of the waveguide 51 and the waveguide 52 connected to the waveguide 53. As a result, at the connection portion between the waveguide 51 and the waveguide 53 and the connection portion between the waveguide 53 and the waveguide 52, it is possible to minimize a difference between a mode field diameter of the mode propagating through the waveguide 51 and the waveguide 52 and a mode field diameter of the mixed mode propagating through the waveguide 53. Therefore, a coupling loss at the connection portions can be minimized, and as a result, the conversion efficiency can be improved.

The inclination angle θ is from 71° to 85°. According to this configuration, the horizontal electric field component and the vertical electric field component in the first mixed mode are likely to be equal to each other as compared with the case where the inclination angle θ is smaller than 71° or larger than 85°. Since the second mixed mode has an orthogonal relationship with the first mixed mode, the horizontal electric field component and the vertical electric field component in the second mixed mode are likely to be equal as in the first mixed mode. Therefore, the conversion efficiency from the TE mode to the TM mode can be further improved. In addition, when the inclination angle θ is from 71° to 85°, confinement of the visible light in the core layer C1 is weakened, and the visible light is more likely to leak into the substrate S and the cladding layer C2. In this state, since the waveguide 53 has an asymmetric shape in the Y-axis direction, the optical axis rotation of the polarization mode of the visible light is likely to occur, and as a result, the conversion efficiency can be improved.

A length (width W1) in the Y-axis direction of a surface in contact with the main surface Sa of each mode converter is from 32% to 48% of a wavelength of the visible light. According to this configuration, as compared with the case where the width W1 is smaller than 32% or larger than 48% of the wavelength of the visible light, the horizontal electric field component and the vertical electric field component in the first mixed mode are likely to be equal to each other. Since the second mixed mode has an orthogonal relationship with the first mixed mode, the horizontal electric field component and the vertical electric field component in the second mixed mode are likely to be equal as in the first mixed mode. Therefore, the conversion efficiency from the TE mode to the TM mode can be further improved. In addition, when the width W1 is from 32% to 48% of the wavelength of the visible light, confinement of the visible light in the core layer C1 is weakened, and the visible light is likely to leak to the substrate S and the cladding layer C2. In this state, since the waveguide 53 has an asymmetric shape in the Y-axis direction, the optical axis rotation of the polarization mode of the visible light is likely to occur, and as a result, the conversion efficiency can be improved.

The length (height T1) of each mode converter in the Z-axis direction is smaller than the wavelength of the visible light. According to this configuration, since the height T1 is smaller than the wavelength of the visible light, the horizontal electric field component and the vertical electric field component in the first mixed mode are likely to be equal to each other. Since the second mixed mode has an orthogonal relationship with the first mixed mode, the horizontal electric field component and the vertical electric field component in the second mixed mode are likely to be equal as in the first mixed mode. Therefore, the conversion efficiency from the TE mode to the TM mode can be further improved. In addition, since the height T1 is smaller than the wavelength of the visible light, confinement of the visible light in the core layer C1 is weakened, and the visible light is likely to leak to the substrate S and the cladding layer C2. In this state, since the waveguide 53 has an asymmetric shape in the Y-axis direction, the optical axis rotation of the polarization mode of the visible light is likely to occur, and as a result, the conversion efficiency can be improved.

The multiplexer 48 is designed so that multiplexing efficiency in a case of multiplexing the red light, the green light, and the blue light in the TM mode becomes higher than multiplexing efficiency in a case of multiplexing the red light, the green light, and the blue light in the TE mode. In the laser module 4 and the optical element 40, the mode converter 42 converts the polarization mode of the red light Lr from the TE mode to the TM mode, the mode converter 43 converts the polarization mode of the green light Lg from the TE mode to the TM mode, and the mode converter 44 converts the polarization mode of the blue light Lb from the TE mode to the TM mode. Accordingly, the multiplexing efficiency in the multiplexer 48 can be improved.

The height of the mode converter 42, the height of the mode converter 43, and the height of the mode converter 44 are the same as each other. According to this configuration, the mode converter 42, the mode converter 43, and the mode converter 44 can be formed on the same substrate S, and the heights thereof can be made the same as each other. Therefore, the optical element 40 can be easily manufactured.

In order to output full-color laser light La by multiplexing the red light Lr, the green light Lg, and the blue light Lb, it is necessary to adjust the optical intensity of light of each color in correspondence with an output color. In order to change the optical intensity of each visible light in each laser light source, a large drive current is required. In the laser module 4 and the optical element 40, the optical intensity of the red light Lr is modulated by the modulator 45, the optical intensity of the green light Lg is modulated by the modulator 46, and the optical intensity of the blue light Lb is modulated by the modulator 47. This makes it possible to output the full-color laser light La without requiring a large drive current.

Since the near-eye wearable device 1 includes the optical element 40, it is possible to project an image onto the retina while improving the conversion efficiency of the visible light polarization mode.

The laser module 4 (optical element 40) may emit the laser light La in the TE mode. For example, when the TM mode visible light is emitted from each laser light source, each visible light is converted into the TE mode in each mode converter. Specifically, the laser light source 411 emits the red light Lr in the TM mode, the laser light source 412 emits the green light Lg in the TM mode, and the laser light source 413 emits the blue light Lb in the TM mode. The mode converter 42 converts the polarization mode of the red light Lr from the TM mode (first polarization mode) to the TE mode (second polarization mode). The mode converter 43 converts the polarization mode of the green light Lg from the TM mode to the TE mode. The mode converter 44 converts the polarization mode of the blue light Lb from the TM mode to the TE mode. In this case, the visible light in the TE mode is incident to each modulator. In order to improve the modulation efficiency in each modulator, the core layer C1 may essentially consist of X-cut lithium niobate, and the optical axis (C-axis) of the lithium niobate may extend in the Y-axis direction.

The incident end and the emission end of each mode converter may be interchanged. That is, the waveguide 52 may be an optical waveguide located at one end (incident end) of each mode converter in the X-axis direction, and the waveguide 51 may be an optical waveguide located at the other end (output end) of each mode converter in the X-axis direction. In this configuration, the laser module 4 (optical element 40) may also emit the TM mode laser light La or may also emit the TE mode laser light La. For example, when the TE mode visible light is emitted from each laser light source, the visible light is converted into the TM mode in each mode converter, and when the TM mode visible light is emitted from each laser light source, the visible light is converted into the TE mode in each mode converter.

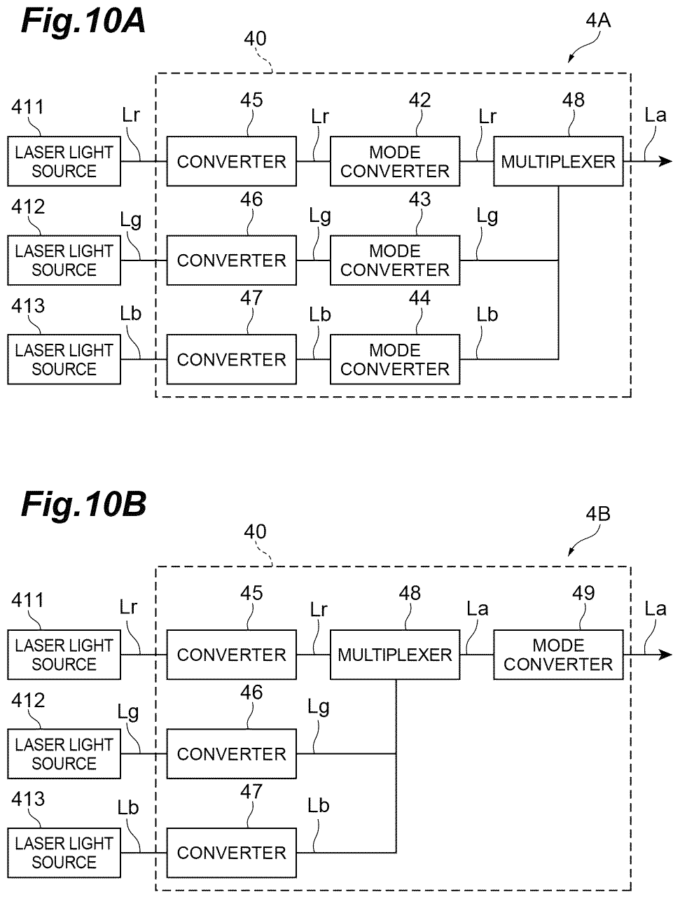

Next, a laser module according to another embodiment will be described with reference to FIG. 10A. FIG. 10A is a block diagram of a laser module according to another embodiment. A laser module 4A illustrated in FIG. 10A emits laser light La in the TE mode. The laser module 4A is mainly different from the laser module 4 in that polarization modes of the visible light emitted from the laser light sources 411, 412, and 413, and positions of the modulators 45, 46, and 47 and the mode converters 42, 43, and 44 are switched.

The laser light source 411 emits the red light Lr in the TM mode. The laser light source 412 emits the green light Lg in the TM mode. The laser light source 413 emits the blue light Lb in the TM mode. The red light Lr is incident to an incident end of the modulator 45 from the laser light source 411. The green light Lg is incident to an incident end of the modulator 46 from the laser light source 412. The blue light Lb is incident to an incident end of the modulator 47 from the laser light source 413. An emission end of the modulator 45 is optically connected to an incident end of the mode converter 42. An emission end of the modulator 46 is optically connected to an incident end of the mode converter 43. An emission end of the modulator 47 is optically connected to an incident end of the mode converter 44. An emission end of the mode converter 42, an emission end of the mode converter 43, and an emission end of the mode converter 44 are optically connected to three incident ends of the multiplexer 48, respectively.

The mode converter 42 converts the polarization mode of the modulated red light Lr from the TM mode (first polarization mode) to the TE mode (second polarization mode). The mode converter 43 converts the polarization mode of the modulated green light Lg from the TM mode to the TE mode. The mode converter 44 converts the polarization mode of the modulated blue light Lb from the TM mode to the TE mode.

As described above, the core layer C1 is a lithium niobate thin film formed on the main surface Sa of the substrate S by sputtering, and the C-axis of lithium niobate extends in the Z-axis direction. Accordingly, the modulation efficiency of each modulator is improved in the TM mode. In the laser module 4A, since the visible light is emitted from each laser light source in the TM mode, after the optical intensity of the visible light in the TM mode is modulated in each modulator, the polarization mode is converted from the TM mode to the TE mode in each mode converter. Then, each visible light of which the polarization mode is converted is multiplexed in the multiplexer 48 to be emitted from the multiplexer 48 to the optical components 5 (refer to FIG. 2) as the TE mode laser light La.

Next, a laser module according to still another embodiment will be described with reference to FIG. 10B. FIG. 10B is a block diagram of a laser module according to still another embodiment. A laser module 4B illustrated in FIG. 10B is mainly different from the laser module 4A in that the laser module 4B includes one mode converter 49 instead of the mode converter 42, the mode converter 43, and the mode converter 44, and that the multiplexer 48 is disposed between each modulator and the mode converter 49.

Specifically, an emission end of the modulator 45, an emission end of the modulator 46, and an emission end of the modulator 47 are optically connected to three incident ends of the multiplexer 48, respectively. The emission end of the multiplexer 48 is optically connected to an incident end of the mode converter 49. A configuration of the mode converter 49 is the same as the configuration of the mode converter 42.

Similarly to the laser module 4A, in the laser module 4B, since the visible light is emitted from each laser light source in the TM mode, the optical intensity of the visible light in the TM mode is modulated in each modulator. Then, the visible light modulated in each modulator is multiplexed in the multiplexer 48, the polarization mode of the multiplexed visible light is converted from the TM mode to the TE mode in the mode converter 49 to be emitted from the mode converter 49 to the optical components 5 (refer to FIG. 2) as the TE mode laser light La.

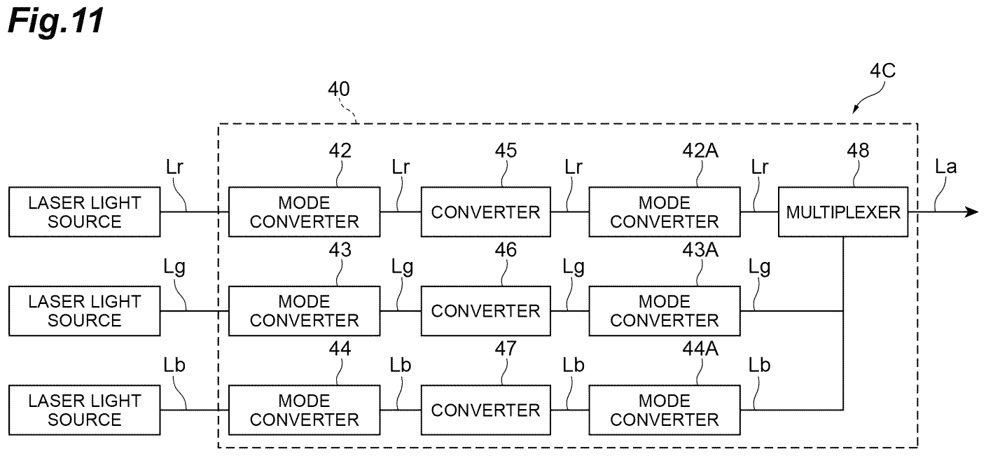

Next, a laser module according to still another embodiment will be described with reference to FIG. 11. FIG. 11 is a block diagram of a laser module according to still another embodiment. A laser module 4C illustrated in FIG. 11 emits the laser light La in the TE mode. The laser module 4C is mainly different from the laser module 4 in that the laser module 4C further includes a mode converter 42A, a mode converter 43A, and a mode converter 44A.

The mode converter 42A is provided between the modulator 45 and the multiplexer 48. An incident end of the mode converter 42A is optically connected to an emission end of the modulator 45, and an emission end of the mode converter 42A is optically connected to an incident end of the multiplexer 48. The mode converter 42A converts the polarization mode of modulated red light Lr from the TM mode to the TE mode.

The mode converter 43A is provided between the modulator 46 and the multiplexer 48. An incident end of the mode converter 43A is optically connected to an emission end of the modulator 46, and an emission end of the mode converter 43A is optically connected to another incident end of the multiplexer 48. The mode converter 43A converts the polarization mode of modulated green light Lg from the TM mode to the TE mode.

The mode converter 44A is provided between the modulator 47 and the multiplexer 48. An incident end of the mode converter 44A is optically connected to an emission end of the modulator 47, and an emission end of the mode converter 44A is optically connected to a still another incident end of the multiplexer 48. The mode converter 44A converts the polarization mode of modulated blue light Lb from the TM mode to the TE mode.

In the laser module 4C, since the visible light is emitted from each laser light source in the TE mode, after the polarization mode of each visible light emitted from each laser light source is converted from the TE mode to the TM mode in each mode converter, the optical intensity of the visible light in the TM mode is modulated in each modulator. Then, the modulated polarization mode of each visible light is converted from the TM mode to the TE mode in each mode converter. Then, each visible light is multiplexed in the multiplexer 48 to be emitted from the multiplexer 48 to the optical components 5 (refer to FIG. 2) as the TE mode laser light La.

In the laser modules 4A, 4B, and 4C, the core layer C1 may essentially consist of X-cut lithium niobate, and the optical axis (C-axis) of the lithium niobate may extend in the Y-axis direction. In this case, the modulation efficiency of each modulator is improved in the TE mode. In the laser modules 4A and 4B, the visible light may be emitted from each laser light source in the TE mode, and the optical intensity of the visible light in the TE mode may be modulated in each modulator. In the laser module 4C, the visible light may be emitted from each laser light source in the TM mode and converted into the TE mode in each mode converter, and then the optical intensity of the visible light in the TE mode may be modulated in each modulator.

### Modification Example

Although the embodiments of the present disclosure have been described above, the present disclosure is not necessarily limited to the above-described embodiments, and various modifications can be made without departing from the gist thereof.

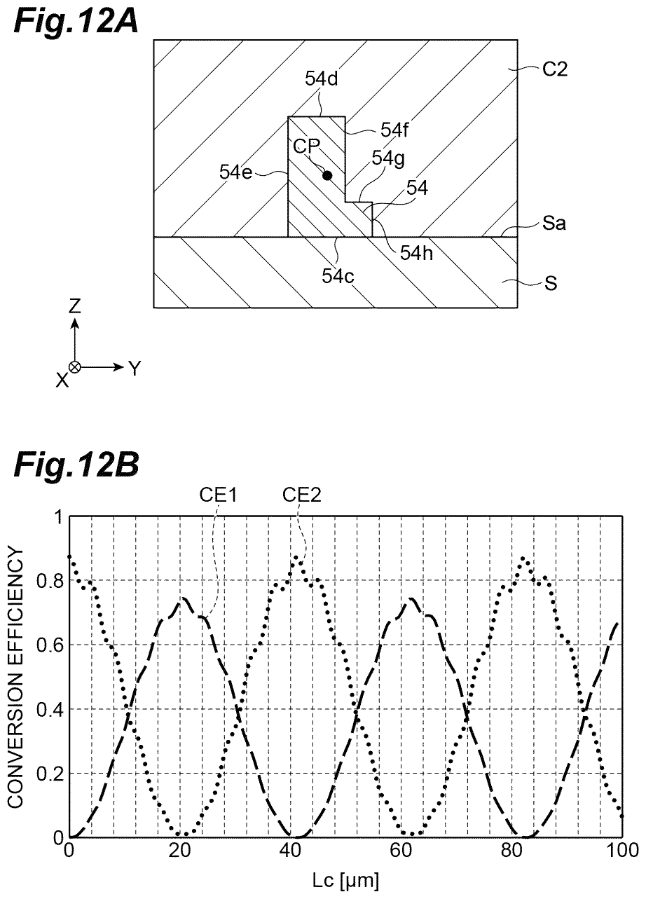

The shape of the waveguide 53 is not limited to the shape illustrated in FIGS. 4 and 6. For example, instead of the waveguide 53, a waveguide 54 having a cross-section illustrated in FIG. 12A may be used. The waveguide 54 is mainly different from the waveguide 53 in a shape thereof. The waveguide 54 has a two-step stepped shape in which a length in the Y-axis direction increases toward the main surface Sa in stages. Similarly to the waveguide 53, the waveguide 54 is asymmetric in the Z-axis direction and asymmetric in the Y-axis direction.

More specifically, the waveguide 54 includes a bottom surface 54c, a top surface 54d, a side surface 54e, a riser surface 54f, a tread surface 54g, and a riser surface 54h. The bottom surface 54c is a surface facing the main surface Sa, and the entire bottom surface 54c is in contact with the main surface Sa. The top surface 54d is provided on a side opposite to the bottom surface 54c in the Z-axis direction and is substantially parallel to the bottom surface 54c. The side surface 54e is a surface connecting one end of the bottom surface 54c and one end of the top surface 54d. The tread surface 54g is provided at a position closer to the main surface Sa than the top surface 54d is, and is a surface substantially parallel to the top surface 54d. The riser surface 54f is a surface connecting the other end of the top surface 54d and one end of the tread surface 54g. The riser surface 54h is a surface connecting the other end of the tread surface 54g and the other end of the bottom surface 54c.

Each of the side surface 54e, the riser surface 54f, and the riser surface 54h is provided so as to form an angle of substantially 90° with respect to the bottom surface 54c (main surface Sa). The top surface 54d and the riser surface 54f constitute a stepped shape corresponding to one step. The tread surface 54g and the riser surface 54h constitute a stepped shape corresponding to another step. The sum of the width of the top surface 54d and the width of the tread surface 54g is equal to the width of the bottom surface 54c.

In the waveguide 54, for example, the horizontal electric field component in the first mixed mode is approximately 45% of the entire field of the first mixed mode. The horizontal electric field component in the second mixed mode is approximately 55% of the entire field of the second mixed mode.

For example, the description will be given by using the waveguide 54 that converts the polarization mode of the red light Lr from the TE mode to the TM mode. When a wavelength of the red light Lr is set to 638 nm, the height of the side surface 54e is set to 560 nm, the width of the bottom surface 54c is set to 280 nm, the height of the riser surface 54f is set to 380 nm, and the width of the tread surface 54g is set to 90 nm, conversion efficiency CE1 and conversion efficiency CE2 illustrated in FIG. 12B are obtained. As illustrated in FIG. 12B, a maximum value of the conversion efficiency CE1 is approximately 0.75, and a maximum value of the conversion efficiency CE2 is approximately 0.9. In this case, the conversion length Lc is calculated to be 20.5 μm by Equation (3). When the conversion length Lc is 20.5 μm, the conversion efficiency at the time of conversion from the TE mode to the TM mode is 0.74.

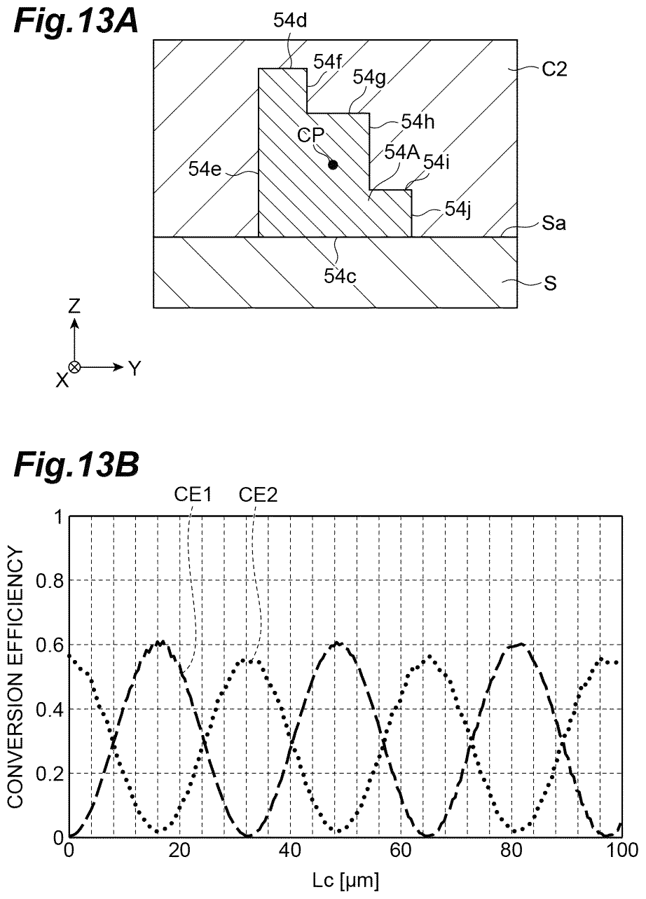

Instead of the waveguide 54, a waveguide 54A having a cross-section illustrated in FIG. 13A may be used. The waveguide 54A has a three-step stepped shape in which the length in the Y-axis direction increases toward the main surface Sa in stages. In other words, the waveguide 54A has a shape obtained by adding a stepped shape corresponding to one step to the stepped shape included in the waveguide 54. Similarly to the waveguides 53 and 54, the waveguide 54A is asymmetric in the Z-axis direction and asymmetric in the Y-axis direction.

More specifically, the waveguide 54A further includes a tread surface 54i and a riser surface 54j in addition to each surface in the waveguide 54. The tread surface 54i is provided at a position closer to the main surface Sa than the tread surface 54g is, and is a surface substantially parallel to the top surface 54d. The riser surface 54j is a surface connecting the other end of the tread surface 54i and the other end of the bottom surface 54c. In the waveguide 54A, the riser surface 54h connects the other end of the tread surface 54g and one end of the tread surface 54i. The riser surface 54j is provided so as to form an angle of substantially 90° with respect to the bottom surface 54c (main surface Sa). The tread surface 54i and the riser surface 54j form a stepped shape corresponding to still another step. The sum of the width of the top surface 54d, the width of the tread surface 54g, and the width of the tread surface 54i is equal to the width of the bottom surface 54c.

In the waveguide 54A, for example, the horizontal electric field component in the first mixed mode is approximately 57% of the entire field of the first mixed mode. The horizontal electric field component in the second mixed mode is approximately 55% of the entire field of the second mixed mode.

For example, the description will be given by using the waveguide 54A that converts the polarization mode of the red light Lr from the TE mode to the TM mode. When a wavelength of the red light Lr is set to 638 nm, the height of the side surface 54e is set to 560 nm, the width of the bottom surface 54c is set to 280 nm, the height of the riser surface 54f is set to 150 nm, the width of the tread surface 54g is set to 120 nm, the height of the riser surface 54h is set to 260 nm, and the width of the tread surface 54i is set to 80 nm, conversion efficiency CE1 and conversion efficiency CE2 illustrated in FIG. 13B are obtained. As illustrated in FIG. 13B, a maximum value of the conversion efficiency CE1 is approximately 0.6, and a maximum value of the conversion efficiency CE2 is approximately 0.55. In this case, the conversion length Lc is calculated to be 16.0 μm by Equation (3). When the conversion length Lc is 16.0 μm, the conversion efficiency at the time of conversion from the TE mode to the TM mode is 0.61.

According to the mode converter including the above-described waveguide 54 or the waveguide 54A, the polarization mode of the visible light can be converted from the TE mode into the TM mode. According to the configuration, the horizontal electric field component and the vertical electric field component in the first mixed mode are likely to be equal to each other. Since the second mixed mode has an orthogonal relationship with the first mixed mode, the horizontal electric field component and the vertical electric field component in the second mixed mode are likely to be equal as in the first mixed mode. Therefore, the conversion efficiency from the TE mode to the TM mode can be improved.

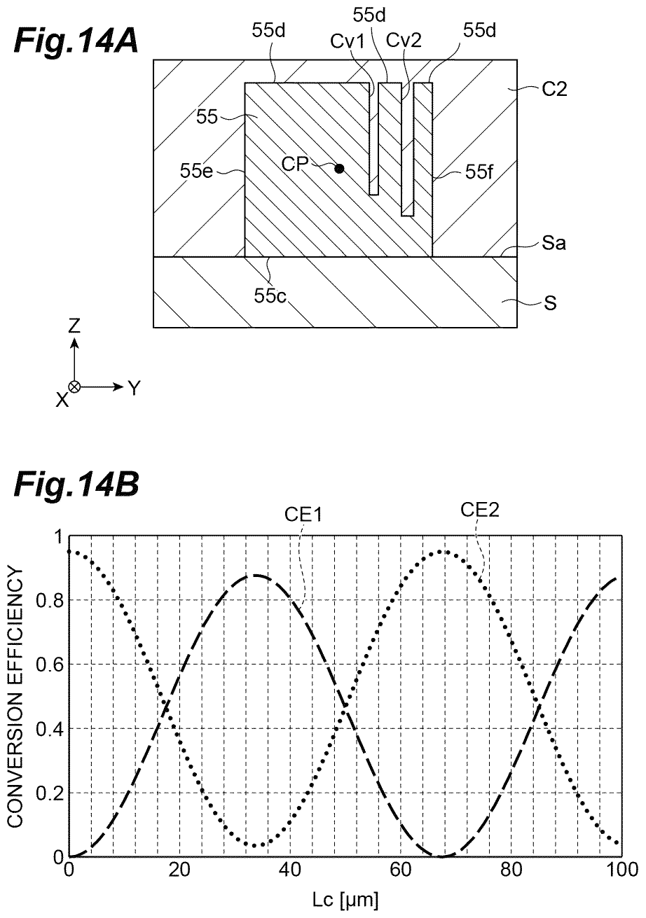

A waveguide 55 illustrated in FIG. 14A may be used instead of the waveguide 53. The waveguide 55 is mainly different from the waveguide 53 in a shape thereof. Similarly to the waveguide 53, the waveguide 55 is asymmetric in the Z-axis direction and asymmetric in the Y-axis direction.

More specifically, the waveguide 55 includes a bottom surface 55c, a top surface 55d, and a pair of side surfaces 55e and 55f connecting the bottom surface 55c and the top surface 55d. The bottom surface 55c is a surface facing the main surface Sa, and the entire bottom surface 55c is in contact with the main surface Sa. The top surface 55d is provided on a side opposite to the bottom surface 55c in the Z-axis direction and is substantially parallel to the bottom surface 55c. The pair of side surfaces 55e and 55f are surfaces connecting the bottom surface 55c and the top surface 55d, and are substantially parallel to each other.

The top surface 55d is provided with a groove Cv1 and a groove Cv2 extending in the X-axis direction and recessed toward the bottom surface 55c. The grooves Cv1 and Cv2 are arranged in this order from the side surface 55e toward the side surface 55f. A cross-sectional shape intersecting (orthogonal to) the X-axis direction of each of the groove Cv1 and the groove Cv2 is a rectangular shape. The length (depth) of the groove Cv1 in the Z-axis direction is shorter than the length (depth) of the groove Cv2 in the Z-axis direction.

In the waveguide 55, for example, the horizontal electric field component in the first mixed mode is approximately 40% of the entire field of the first mixed mode. The horizontal electric field component in the second mixed mode is approximately 60% of the entire field of the second mixed mode.

For example, the description will be given by using the waveguide 55 that converts the polarization mode of the red light Lr from the TE mode to the TM mode. In a case where a wavelength of the red light Lr is set to 638 nm, a width of the bottom surface 55c is set to 280 nm, a separation distance between the side surface 55e and the groove Cv1 is set to 170 nm, a separation distance between the groove Cv1 and the groove Cv2 is set to 40 nm, a width of the groove Cv1 is set to 20 nm, a width of the groove Cv2 is set to 20 nm, a height of the side surface 55e is set to 400 nm, a depth of the groove Cv1 is set to 250 nm, and a depth of the groove Cv2 is set to 300 nm, conversion efficiency CE1 and conversion efficiency CE2 illustrated in FIG. 14B are obtained. As illustrated in FIG. 14B, a maximum value of the conversion efficiency CE1 is approximately 0.9, and a maximum value of the conversion efficiency CE2 is approximately 0.95. In this case, the conversion length Lc is calculated to be 33.5 μm by Equation (3). When the conversion length Lc is 33.5 μm, the conversion efficiency at the time of conversion from the TE mode to the TM mode is 0.87.

According to the mode converter including the waveguide 55 described above, the conversion efficiency of the polarization mode of the visible light can be improved as compared with the mode converter including the waveguide 54 or the waveguide 54A. In addition, since the grooves Cv1 and Cv2 are provided in the waveguide 55, it is possible to make the waveguide 55 asymmetric in the Y-axis direction while suppressing a decrease in the cross-sectional area of the waveguide 55 as compared with the waveguide 54 and the waveguide 54A. Therefore, the cross-sectional area of the waveguide 55 is suppressed from becoming extremely small with respect to cross-sectional areas of the waveguide 51 and the waveguide 52 connected to the waveguide 55. As a result, at a connection portion between the waveguide 51 and the waveguide 55 and a connection portion between the waveguide 55 and the waveguide 52, it is possible to minimize a difference between a mode field diameter of the mode propagating through the waveguide 51 and the waveguide 52 and a mode field diameter of the mixed mode propagating through the waveguide 55. Therefore, a coupling loss at the connection portions can be minimized, and as a result, the conversion efficiency can be improved.

### EXAMPLES

Hereinafter, in order to describe the above effect, the present disclosure will be described in more detail by way of examples. The present disclosure is not limited to these examples.

### <Evaluation of Conversion Loss in Ratio of Width W1 to Wavelength λ of Visible Light>

An influence of a ratio of the width W1 to the wavelength λ of the visible light on the conversion loss was evaluated. For each of red light, green light, and blue light, a maximum conversion efficiency at each value of the width W1 was calculated by changing the value of the width W1 by using a mode converter having the same structure as the mode converter 42 illustrated in FIG. 3. The maximum conversion efficiency was calculated when the height T1 was set to 0.3 μm, the wavelength λ of red light was set to 638 nm, the wavelength λ of green light was set to 520 nm, the wavelength λ of blue light was set to 455 nm, and the polarization mode of the visible light was converted from the TE fundamental mode to the TM fundamental mode. The conversion efficiency represents the optical intensity of the visible light in the TM fundamental mode when the optical intensity of the visible light in the TE fundamental mode is set to 1. A conversion loss [dB] is obtained by converting the maximum conversion efficiency into a unit of dB.

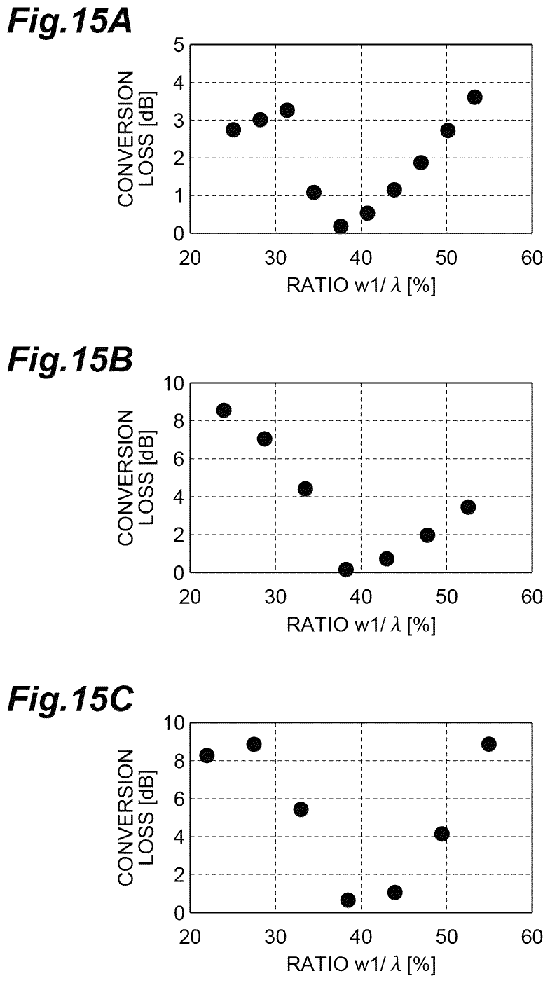

The calculation results of the red light are shown in Table 1 and FIG. 15A. Table 1 shows the width W2 [μm] and the conversion length Lc [μm] when the maximum conversion efficiency is obtained at each value of the width W1, and the ratio W1/λ [%] in addition to the width W1, the maximum conversion efficiency, and the conversion loss. The horizontal axis in FIG. 15A represents the ratio W1/λ [%], and the vertical axis in FIG. 15A represents the conversion loss [dB]. A case where the maximum conversion efficiency exceeds 0.60 or the conversion loss falls below 2.2 dB will be described as a case where high conversion efficiency is realized.

TABLE 1

| | | | | Maximum | |
|---|---|---|---|---|---|
| | | | | conversion | Conversion |
| W1/λ[%] | W1 [μm] | W2 [μm] | Lc [μm] | efficiency | loss [dB] |
| 25 | 0.16 | 0.11 | 47 | 0.53 | 2.7 |
| 28 | 0.18 | 0.09 | 31 | 0.50 | 3.0 |
| 31 | 0.20 | 0.07 | 23 | 0.47 | 3.3 |
| 34 | 0.22 | 0.19 | 33 | 0.78 | 1.1 |
| 38 | 0.24 | 0.17 | 17 | 0.96 | 0.2 |
| 41 | 0.26 | 0.15 | 12 | 0.88 | 0.5 |
| 44 | 0.28 | 0.13 | 9 | 0.77 | 1.2 |
| 47 | 0.30 | 0.11 | 8 | 0.65 | 1.9 |
| 50 | 0.32 | 0.09 | 7 | 0.53 | 2.7 |
| 53 | 0.34 | 0.09 | 6 | 0.44 | 3.6 |

According to Table 1 and FIG. 15A, when the ratio W1/λ is in a range of 34% to 47%, the maximum conversion efficiency exceeds 0.60 and the conversion loss falls below 2.2 dB. According to the amount of variation (slope) of the conversion loss per unit ratio W1/λ when the ratio W1/λ varies from 31% to 34%, it can be estimated that the conversion loss at a ratio W1/λ of 32% is less than 2.2 dB. Similarly, according to the amount of variation (slope) of the conversion loss per unit ratio W1/λ when the ratio W1/λ varies from 47% to 50%, it can be estimated that the conversion loss at the ratio W1/λ of 48% is less than 2.2 dB. As described above, it will be understood that high conversion efficiency can be realized when the ratio W1/λ is in a range of 32% to 48%.

The calculation results of the green light are shown in Table 2 and FIG. 15B. Table 2 shows the width W2 [μm] and the conversion length Lc [μm] when the maximum conversion efficiency is obtained at each value of the width W1, and the ratio W1/λ [%] in addition to the width W1, the maximum conversion efficiency, and the conversion loss. The horizontal axis in FIG. 15B represents the ratio W1/λ [%], and the vertical axis in FIG. 15B represents the conversion loss [dB].

TABLE 2

| | | | | Maximum | |
|---|---|---|---|---|---|
| | | | | conversion | Conversion |
| W1/λ[%] | W1 [μm] | W2 [μm] | Lc [μm] | efficiency | loss [dB] |
| 19 | 0.10 | 0.07 | 32 | 0.03 | 15.8 |
| 24 | 0.13 | 0.06 | 25 | 0.14 | 8.6 |
| 29 | 0.15 | 0.05 | 21 | 0.20 | 7.0 |
| 34 | 0.18 | 0.02 | 23 | 0.36 | 4.4 |
| 38 | 0.20 | 0.15 | 18 | 0.96 | 0.2 |
| 43 | 0.23 | 0.12 | 8 | 0.85 | 0.7 |
| 48 | 0.25 | 0.10 | 6 | 0.64 | 2.0 |
| 53 | 0.28 | 0.07 | 5 | 0.45 | 3.4 |

According to Table 2 and FIG. 15B, when the ratio W1/λ is in a range of 38% to 48%, the maximum conversion efficiency exceeds 0.60 and the conversion loss falls below 2.2 dB. As described above, it will be understood that high conversion efficiency can be realized when the ratio W1/λ is in a range of 38% to 48%.

The calculation results of the blue light are shown in Table 3 and FIG. 15C. Table 3 shows the width W2 [μm] and the conversion length Lc [μm] when the maximum conversion efficiency is obtained at each value of the width W1, and the ratio W1/λ [%] in addition to the width W1, the maximum conversion efficiency, and the conversion loss. The horizontal axis in FIG. 15C represents the ratio W1/λ [%], and the vertical axis in FIG. 15C represents the conversion loss [dB].

TABLE 3

| | | | | Maximum | |
|---|---|---|---|---|---|
| | | | | conversion | Conversion |
| W1/λ[%] | W1 [μm] | W2 [μm] | Lc [μm] | efficiency | loss [dB] |
| 22 | 0.10 | 0.03 | 41 | 0.15 | 8.3 |
| 27 | 0.13 | 0.04 | 3 | 0.13 | 8.9 |
| 33 | 0.15 | 0.04 | 10 | 0.29 | 5.4 |
| 38 | 0.18 | 0.13 | 14 | 0.86 | 0.6 |
| 44 | 0.20 | 0.09 | 8 | 0.78 | 1.1 |
| 49 | 0.23 | 0.08 | 5 | 0.39 | 4.1 |
| 55 | 0.25 | 0.06 | 4 | 0.13 | 8.9 |

According to Table 3 and FIG. 15C, when the ratio W1/λ is in a range of 38% to 44%, the maximum conversion efficiency exceeds 0.60 and the conversion loss falls below 2.2 dB. As described above, it will be understood that high conversion efficiency can be realized when the ratio W1/λ is in a range of 38% to 44%.

### <Evaluation of Conversion Loss at Height T1>

An influence of the height T1 on the conversion loss was evaluated. For the red light, the maximum conversion efficiency at each value of the height T1 was calculated by changing the value of the height T1 using a mode converter having the same structure as the mode converter 42 illustrated in FIG. 3. The maximum conversion efficiency was calculated when the wavelength λ was set to 638 nm and the polarization mode of red light was converted from the TE fundamental mode to the TM fundamental mode.

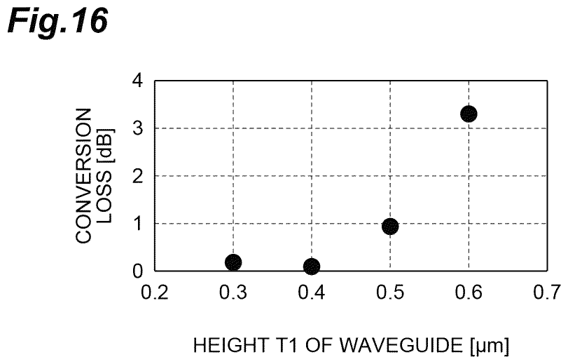

The calculation results are shown in Table 4 and FIG. 16. Table 4 shows the width W1 [μm], the width W2 [μm], and the conversion length Lc [μm] when the maximum conversion efficiency is obtained at each value of the height T1 in addition to the height T1, the maximum conversion efficiency, and the conversion loss. The horizontal axis in FIG. 16 represents the height T1 [μm] of the waveguide, and the vertical axis in FIG. 16 represents the conversion loss [dB].

TABLE 4

| | | | | Maximum | |
|---|---|---|---|---|---|
| | | | | conversion | Conversion |
| T1 [μm] | W1 [μm] | W2 [μm] | Lc [μm] | efficiency | loss [dB] |
| 0.3 | 0.24 | 0.17 | 17 | 0.96 | 0.2 |
| 0.4 | 0.25 | 0.20 | 31 | 0.98 | 0.1 |
| 0.5 | 0.25 | 0.20 | 19 | 0.81 | 0.9 |
| 0.6 | 0.25 | 0.20 | 53 | 0.47 | 3.3 |

According to Table 4 and FIG. 16, when the height T1 is 0.5 μm or less, the maximum conversion efficiency exceeds 0.6, and the conversion loss falls below 2.2 dB. As described above, it will be understood that high conversion efficiency can be realized when the height T1 is smaller than the wavelength λ (638 nm) of the visible light used in this calculation.

### <Evaluation of Conversion Loss at Inclination Angle θ>

An influence of the inclination angle θ on the conversion loss was evaluated. For each of the red light, the green light, and the blue light, the conversion loss at each value of the inclination angle θ was calculated by changing the value of the inclination angle θ using a mode converter having the same structure as the mode converter 42 illustrated in FIG. 3. For evaluation of the red light, a mode converter having a conversion length Lc of 16 μm and a mode converter having a conversion length Lc of 18 μm were used, and the wavelength λ of the red light was set to 638 nm, the height T1 was set to 0.3 μm, and the width W1 was set to 0.24 μm. By changing the width W2, the conversion loss when the polarization mode of the red light is converted from the TE fundamental mode to the TM fundamental mode was calculated at each value of the inclination angle θ.

For evaluation of the green light, a mode converter having a conversion length Lc of 14 μm and a mode converter having a conversion length Lc of 16 μm were used, and the wavelength A of the green light was set to 520 nm, the height T1 was set to 0.3 μm, and the width W1 was set to 0.20 μm. By changing the width W2, the conversion loss when the polarization mode of the green light is converted from the TE fundamental mode to the TM fundamental mode was calculated at each value of the inclination angle θ. For the evaluation of the blue light, a mode converter having a conversion length Lc of 12 μm and a mode converter having a conversion length Lc of 14 μm were used, and the wavelength A of the blue light was set to 455 nm, the height T1 was set to 0.3 μm, and the width W1 was set to 0.18 μm. By changing the width W2, the conversion loss when the polarization mode of the blue light is converted from the TE fundamental mode to the TM fundamental mode was calculated at each value of the inclination angle θ.

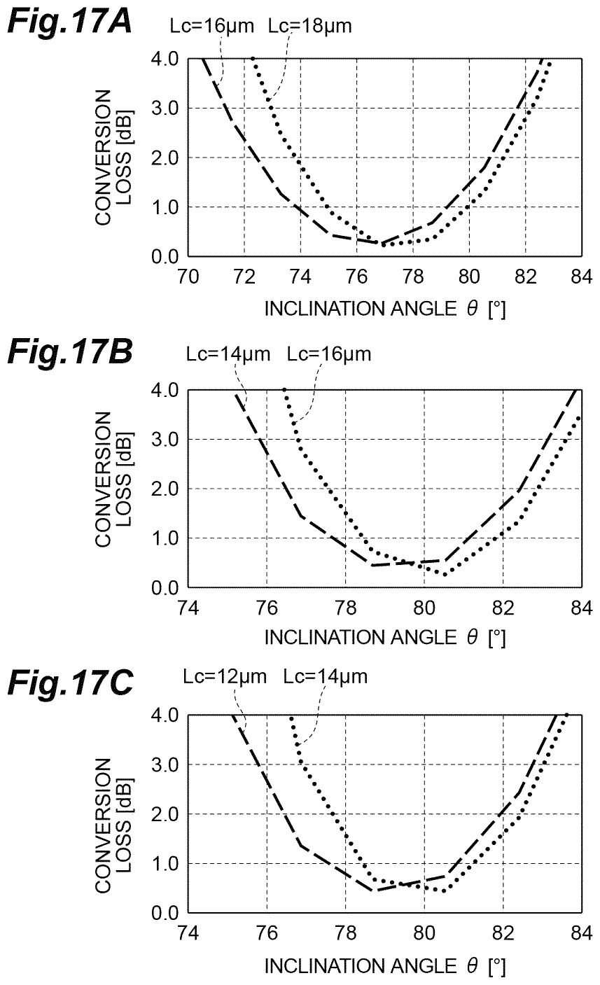

The calculation results of the red light are illustrated in FIG. 17A. The horizontal axis in FIG. 17A represents the inclination angle θ [°], and the vertical axis in FIG. 17A represents the conversion loss [dB]. According to FIG. 17A, in a case where the conversion length Lc is 16 μm, the conversion loss is less than 2.2 dB at the inclination angle θ of 73° to 81°, and it will be understood that high conversion efficiency can be realized. In a case where the conversion length Lc is 18 μm, the conversion loss is less than 2.2 dB at the inclination angle θ of 74° to 81°, and it will be understood that high conversion efficiency can be realized.

The calculation results of the green light are illustrated in FIG. 17B. The horizontal axis in FIG. 17B represents the inclination angle θ [°], and the vertical axis in FIG. 17B represents the conversion loss [dB]. According to FIG. 17B, in a case where the conversion length Lc is 14 μm, the conversion loss is less than 2.2 dB at the inclination angle θ of 77° to 82°, and it will be understood that high conversion efficiency can be realized. In a case where the conversion length Lc is 16 μm, the conversion loss is less than 2.2 dB at the inclination angle θ of 78° to 83°, and it will be understood that high conversion efficiency can be realized.

The calculation results of the blue light are illustrated in FIG. 17C. The horizontal axis in FIG. 17C represents the inclination angle θ [°], and the vertical axis in FIG. 17C represents the conversion loss [dB]. According to FIG. 17C, in a case where the conversion length Lc is 12 μm, the conversion loss is less than 2.2 dB at the inclination angle θ of 77° to 82°, and it will be understood that high conversion efficiency can be realized. In a case where the conversion length Lc is 14 μm, the conversion loss is less than 2.2 dB at the inclination angle θ of 78° to 82°, and it will be understood that high conversion efficiency can be realized.

From the above evaluation results, as an example of the range of the inclination angle θ in which high conversion efficiency can be realized, 73° to 83°, which is the maximum range in FIGS. 17A to 17C, can be exemplified. From the viewpoint of increasing the degree of freedom in designing the waveguide, the range of the inclination angle θ may be 71° to 85° extended by +2° from the above-described range.

### ADDITIONAL STATEMENTS

### Clause 1

An optical element comprising:
a substrate including a main surface; and
a core layer that is provided on the main surface and consists of a material having an electro-optical effect,
wherein the core layer includes a mode converter extending in a first direction along the main surface, the mode converter configured to convert a polarization mode of visible light between a TM mode and a TE mode,
the mode converter includes:
a first waveguide to which the visible light is incident in a first polarization mode that is one polarization mode of the TE mode and the TM mode;
a second waveguide configured to emit the visible light in a second polarization mode that is the other polarization mode of the TE mode and the TM mode; and
a third waveguide provided between the first waveguide and the second waveguide, the third waveguide configured to convert the visible light from the first polarization mode to the second polarization mode, and
the third waveguide has an asymmetric shape in a second direction along the main surface, the second direction intersecting the first direction.

### Clause 2

The optical element according to Clause 1,
wherein the third waveguide includes:
a bottom surface facing the main surface;
a top surface provided on a side opposite to the bottom surface in a third direction intersecting the first direction and the second direction; and
an inclined surface connecting the top surface and the bottom surface, and
the third waveguide has a columnar shape in which a length in the second direction continuously increases from the top surface to the bottom surface.

### Clause 3

The optical element according to Clause 2,
wherein an inclination angle between the inclined surface and the main surface is from 71° to 85°.

### Clause 4

The optical element according to Clause 1,
wherein the third waveguide has a stepped shape in which a length in the second direction increases as approaching the main surface in stages.

### Clause 5

The optical element according to Clause 1,
wherein the third waveguide includes a bottom surface facing the main surface and a top surface provided on a side opposite to the bottom surface in a third direction intersecting the first direction and the second direction, and
the top surface is provided with a groove extending in the first direction and recessed toward the bottom surface.

### Clause 6

The optical element according to any one of Clauses 1 to 5,
wherein a length of a surface of the mode converter in contact with the main surface in the second direction is from 32% to 48% of a wavelength of the visible light.

### Clause 7

The optical element according to any one of Clauses 1 to 6,
wherein a length of the mode converter in a third direction intersecting the first direction and the second direction is smaller than a wavelength of the visible light.

### Clause 8

The optical element according to any one of Clauses 1 to 7,
wherein the core layer includes,
a first mode converter that is the mode converter configured to convert a polarization mode of red light from the first polarization mode to the second polarization mode;
a second mode converter that is the mode converter configured to convert a polarization mode of green light from the first polarization mode to the second polarization mode;
a third mode converter that is the mode converter configured to convert a polarization mode of blue light from the first polarization mode to the second polarization mode; and
a multiplexer configured to multiplex the red light, the green light, and the blue light to emit multiplexed laser light.

### Clause 9

The optical element according to Clause 8,
wherein lengths of the first mode converter, the second mode converter, and the third mode converter in a third direction intersecting the first direction and the second direction are the same as each other.

### Clause 10

The optical element according to Clause 8 or 9,
wherein the core layer further includes:
a first modulator configured to modulate an optical intensity of the red light;
a second modulator configured to modulate an optical intensity of the green light; and
a third modulator configured to modulate an optical intensity of the blue light.

### Clause 11

A laser module including:
the optical element according to any one of Clauses 8 to 10;
a first laser light source configured to emit the red light in the first polarization mode;
a second laser light source configured to emit the green light in the first polarization mode; and
a third laser light source configured to emit the blue light in the first polarization mode.

### Clause 12

A near-eye wearable device including:
the laser module according to Clause 11;
a movable mirror configured to perform scanning by using the laser light emitted from the laser module; and
a reflector configured to reflect the laser light that has passed through the movable mirror and to guide the laser light to a retina of a user wearing the near-eye wearable device to project an image onto the

What is claimed is:

1. An optical element comprising:
a substrate including a main surface; and
a core layer that is provided on the main surface and consists of a material having an electro-optical effect,
wherein the core layer includes a mode converter extending in a first direction along the main surface, the mode converter configured to convert a polarization mode of visible light between a TM mode and a TE mode,
the mode converter includes:
a first waveguide to which the visible light is incident in a first polarization mode that is one polarization mode of the TE mode and the TM mode;
a second waveguide configured to emit the visible light in a second polarization mode that is the other polarization mode of the TE mode and the TM mode; and
a third waveguide provided between the first waveguide and the second waveguide, the third waveguide configured to convert the visible light from the first polarization mode to the second polarization mode, and
the third waveguide has an asymmetric shape in a second direction along the main surface, the second direction intersecting the first direction.

2. The optical element according to claim 1,
wherein the third waveguide includes:
a bottom surface facing the main surface;
a top surface provided on a side opposite to the bottom surface in a third direction intersecting the first direction and the second direction; and
an inclined surface connecting the top surface and the bottom surface, and
the third waveguide has a columnar shape in which a length in the second direction continuously increases from the top surface to the bottom surface.

3. The optical element according to claim 2,
wherein an inclination angle between the inclined surface and the main surface is from 71° to 85°.

4. The optical element according to claim 1,
wherein the third waveguide has a stepped shape in which a length in the second direction increases as approaching the main surface in stages.

5. The optical element according to claim 1,
wherein the third waveguide includes a bottom surface facing the main surface and a top surface provided on a side opposite to the bottom surface in a third direction intersecting the first direction and the second direction, and
the top surface is provided with a groove extending in the first direction and recessed toward the bottom surface.

6. The optical element according to claim 1,
wherein a length of a surface of the mode converter in contact with the main surface in the second direction is from 32% to 48% of a wavelength of the visible light.

7. The optical element according to claim 1,
wherein a length of the mode converter in a third direction intersecting the first direction and the second direction is smaller than a wavelength of the visible light.

8. The optical element according to claim 1,
wherein the core layer includes:
a first mode converter that is the mode converter configured to convert a polarization mode of red light from the first polarization mode to the second polarization mode;
a second mode converter that is the mode converter configured to convert a polarization mode of green light from the first polarization mode to the second polarization mode;
a third mode converter that is the mode converter configured to convert a polarization mode of blue light from the first polarization mode to the second polarization mode; and
a multiplexer configured to multiplex the red light, the green light, and the blue light to emit multiplexed laser light.

9. The optical element according to claim 8,
wherein lengths of the first mode converter, the second mode converter, and the third mode converter in a third direction intersecting the first direction and the second direction are the same as each other.

10. The optical element according to claim 8,
wherein the core layer further includes:
a first modulator configured to modulate an optical intensity of the red light;
a second modulator configured to modulate an optical intensity of the green light; and
a third modulator configured to modulate an optical intensity of the blue light.

11. A laser module comprising:
the optical element according to claim 8;
a first laser light source configured to emit the red light in the first polarization mode;
a second laser light source configured to emit the green light in the first polarization mode; and
a third laser light source configured to emit the blue light in the first polarization mode.

12. A near-eye wearable device comprising:
the laser module according to claim 11;
a movable mirror configured to perform scanning by using the laser light emitted from the laser module; and
a reflector configured to reflect the laser light that has passed through the movable mirror and to guide the laser light to a retina of a user wearing the near-eye wearable device to project an image onto the retina.
